(19) United States
(12) Patent Application Publication
(10) Pub. No.: US 2008/0009574 A1
(43) Pub. Date: Jan. 10, 2008

(54) Polyamide-Polyester Polymer Blends and Methods of Making the Same

(75) Inventors: Daniel Allen Huenefeld, Atlanta, GA (US); Carl Steven Nichols, Waxhaw, NC (US)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: WELLMAN, INC., Fort Mill, SC (US)

(21) Appl. No.: 11/780,926

(22) Filed: Jul. 20, 2007

Related U.S. Application Data
(63) Continuation-in-part of application No. PCT/US06/02385, filed on Jan. 23, 2006.
(60) Provisional application No. 60/807,997, filed on Jul. 21, 2006.
(60) Provisional application No. 60/646,335, filed on Jan. 24, 2005.

(51) Int. Cl. C08G 63/183; C08K 5/13

(52) U.S. Cl. 524/384; 524/605; 525/451

(57) ABSTRACT

The present invention relates to polyamide-polyester barrier blends that possess improved gas barrier, clarity, and organoleptic properties, as well as containers (e.g., bottles), sheets, and films formed from such barrier resins. The invention further relates to polyamide-compatible polyethylene terephthalate resins that are useful in forming these improved polyamide-polyester polymer blends. The invention still further relates to cost-effective recycling of articles formed from polyamide-polyester polymer blends.

### CROSS-REFERENCE TO PRIORITY APPLICATIONS

This application is a continuation-in-part of commonly assigned International Patent Application No. PCT/US06/02385 for Improved Polyamide-Polyester Polymer Blends and Methods of Making the Same, filed Jan. 23, 2006, which itself claims the benefit of commonly assigned U.S. Provisional Patent Application Ser. No. 60/646,335, for Polyamide-Compatible Polyethylene Terephthalate Resins, filed Jan. 24, 2005. This application further claims the benefit of commonly assigned U.S. Provisional Patent Application Ser. No. 60/807,997, for Polyamide-Polyester Polymer Blends and the Cost-Effective Recycling Thereof, filed Jul. 21, 2006. This application incorporates entirely by reference each of the foregoing international and provisional patent applications.

### CROSS-REFERENCE TO COMMONLY-ASSIGNED APPLICATIONS

This application incorporates entirely by reference the following commonly assigned patent and patent applications, which disclose polymer resins and polymer processes: U.S. patent application Ser. No. 09/456,253, for a Method of preparing Modified Polyester Bottle Resins, filed Dec. 7, 1999, now U.S. Pat. No. 6,284,866; U.S. patent application Ser. No. 09/851,240, for a Method of preparing Modified Polyester Bottle Resins, filed May 8, 2001, now U.S. Pat. No. 6,335,422; U.S. patent application Ser. No. 10/850,269, for Methods of Making Titanium-Catalyzed Polyester Resins, filed May 20, 2004, (and published Nov. 24, 2005, as Publication No. 2005/0261462 A1); U.S. patent application Ser. No. 10/850,918, for Slow-Crystallizing Polyester Resins, filed May 21, 2004, now U.S. Pat. No. 7,129,317; U.S. patent application Ser. No. 10/996,789, for Polyester Preforms Useful for Enhanced Heat-Set Bottles, filed Nov. 24, 2004, now U.S. Pat. No. 7,094,863; U.S. patent application Ser. No. 11/466,066, filed Aug. 21, 2006, for Polyester Resins for High-Strength Articles, (and published Mar. 15, 2007, as Publication No. 2007/0059465 A1); U.S. patent application Ser. No. 11/046,481, for Methods of Making Imide-Modified Polyester Resins, filed Jan. 28, 2005, now U.S. Pat. No. 7,238,770; International Patent Application No. PCT/US04/16375 for Slow-Crystallizing Polyester Resins, filed May 21, 2004, (and published Dec. 2, 2004, as Publication No. WO 2004/104080); U.S. Provisional Patent Application Ser. No. 60/739,498, for Polyester Resins for High-Efficiency Injection Molding, filed Nov. 23, 2005; International Patent Application No. PCT/US04/39726 for Methods of Making Titanium-Catalyzed Polyethylene Terephthalate Resins, filed Nov. 24, 2004, (and published Nov. 3, 2005, as Publication No. WO 2005/103110); International Patent Application No. PCT/US06/61187 for Polyester Resins for High-Efficiency Injection Molding, filed Nov. 22, 2006 (and published May 31, 2007, as Publication No. WO 2007/062384); International Patent Application No. PCT/US05/03149 for Imide-Modified Polyester Resins and Methods of Making the Same, filed Jan. 28, 2005, (and published Aug. 11, 2005, as Publication No. WO 2005/073272); International Patent Application No. PCT/US07/67392 for Methods for Making Polyester Resins in Falling Film Melt Polycondensation Reactors, filed Apr. 25, 2007; International Patent Application No. PCT/US07/73224 for Solid Phase Polymerization Catalyst System, filed Jul. 11, 2007; and International Patent Application No. PCT/US07/73259 for Composite Solid Phase Polymerization Catalyst, filed Jul. 11, 2007.

This application further incorporates entirely by reference the following commonly assigned patents and patent applications, which disclose methods for introducing additives to polymers: Ser. No. 08/650,291 for a Method of Post-Polymerization Stabilization of High Activity Catalysts in Continuous Polyethylene Terephthalate Production, filed May 20, 1996, now U.S. Pat. No. 5,898,058; Ser. No. 09/738,150, for Methods of Post-Polymerization Injection in Continuous Polyethylene Terephthalate Production, filed Dec. 15, 2000, now U.S. Pat. No. 6,599,596; Ser. No. 09/932,150, for Methods of Post-Polymerization Extruder Injection in Polyethylene Terephthalate Production, filed Aug. 17, 2001, now U.S. Pat. No. 6,569,991; Ser. No. 10/017,612, for Methods of Post-Polymerization Injection in Condensation Polymer Production, filed Dec. 14, 2001, now U.S. Pat. No. 6,573,359; Ser. No. 10/017,400, for Methods of Post-Polymerization Extruder Injection in Condensation Polymer Production, filed Dec. 14, 2001, now U.S. Pat. No. 6,590,069; Ser. No. 10/628,077, for Methods for the Late Introduction of Additives into Polyethylene Terephthalate, filed Jul. 25, 2003, now U.S. Pat. No. 6,803,082; and Ser. No. 10/962,167, for Methods for Introducing Additives into Polyethylene Terephthalate, filed Oct. 8, 2004, (and published Aug. 4, 2005, as Publication No. 2005/0170175 A1).

This application further incorporates entirely by reference the following commonly assigned patents and patent applications, which disclose polymer resins having reduced frictional properties and associated methods: Ser. No. 09/738,619, for Polyester Bottle Resins Having Reduced Frictional Properties and Methods for Making the Same, filed Dec. 15, 2000, now U.S. Pat. No. 6,500,890; Ser. No. 10/177,932 for Methods for Making Polyester Bottle Resins Having Reduced Frictional Properties, filed Jun. 21, 2002, now U.S. Pat. No. 6,710,158; Ser. No. 10/176,737 for Polymer Resins Having Reduced Frictional Properties, filed Jun. 21, 2002, now U.S. Pat. No. 6,727,306; and International Patent Application No. PCT/US06/044185, for Alumina-Enhanced Polyester Resins and Methods for Making the Same, filed Nov. 14, 2006 (and published May 24, 2007, as Publication No. WO 2007/059128).

### FIELD OF THE INVENTION

The present invention relates to polyamide-compatible polyethylene terephthalate resins, which are useful in forming polyamide-polyester barrier blends that possess improved gas barrier, clarity, and organoleptic properties. The invention also relates to methods of forming both polyamide-compatible polyethylene terephthalate polymers and polyamide-polyester barrier blends.

### BACKGROUND OF THE INVENTION

Because of their strength, heat resistance, and chemical resistance, polyester containers, films, sheets, and fibers are an integral component in numerous consumer products manufactured worldwide. In this regard, most commercial polyester used for polyester containers, films, sheets, and fibers is polyethylene terephthalate polyester.

Polyester resins, especially polyethylene terephthalate and its copolyesters, are also widely used to produce rigid packaging, such as 16-ounce (˜0.5 liter) and two-liter soft drink containers. In this regard, polyester packages produced by stretch-blow molding possess outstanding strength, clarity, and shatter resistance. Moreover, for many applications polyester possesses satisfactory—if not excellent—gas barrier and organoleptic properties, too. Consequently, lightweight plastics have virtually replaced glass in packaging numerous consumer products (e.g., carbonated soft drinks, fruit juices, and peanut butter). For other consumer products (e.g., beer), glass and aluminum continue to be the favored packaging materials.

Indeed, for some consumable products polyester packaging provides inadequate shelf life. For other consumable products, polyester packaging provides satisfactory shelf life. Even so, suppliers and retailers would benefit from improved performance in this regard. Accordingly, there is a desire to further enhance the gas barrier properties of polyester resins that are used to package food products, such as carbonated soft drinks and beer.

To improve shelf life of polyester packages, various polyesters have been combined with polyamides (i.e., nylons), which typically possess outstanding gas barrier properties. Unfortunately, polyamides and polyesters have a poor affinity for one another.

For example, to improve the gas barrier properties of polyester packaging, internal and external surface layers (i.e., coatings) have been applied as barrier agents. Likewise, containers having multiple polyester and polyamide layers (i.e., multilayer containers) have been introduced to improve barrier characteristics. Such layered containers possess improved gas barrier properties, but introduce corollary problems. In some cases, the respective polyester and nylon layers may be distinctly visible. In other cases, bottles made with such layers may be so hazy as to be opaque. Such conditions are unacceptable in the packaged food industry. Furthermore, multilayered containers possess poor impact resistance and tend to delaminate under pressure (i.e., poor lamination characteristics).

To enhance gas barrier properties, polyamides have been blended with various polyesters, including polyethylene terephthalate (PET), polybutylene terephthalate (PBT), polypropylene terephthalate (PPT), polyethylene naphthalate (PEN), polybutylene naphthanoate (PBN), polypropylene naphthanoate (PPN), polycyclohexane dimethanol terephthalate (PCT), polycyclohexylene dimethylene terephthalate, glycol (PCTG), and polycyclohexylene dimethylene terephthalate acid (PCTA). Because polyamides and polyesters are generally incompatible, however, mixing nylon-based barrier agents with polyesters can lead to unacceptably hazy bottles. To address this haze problem, compatibilizer additives have been introduced to improve the miscibility between polyesters and polyamides.

For example, U.S. Patent Application Publication No. 2004/0013833 (Lee et al.) discloses the use of isophthalic acid (IPA) derivatives as polyamide-polyester compatibilizers. Similarly, U.S. Pat. No. 5,300,572 (Tajima) discloses adding various classes of aromatic carboxylic monomers at charge to improve the compatibility of polyamides with various kinds of polyesters. In this regard, U.S. Pat. No. 5,300,572 discloses generic formulas for a broad range of possible compatibilizers. For example, in the disclosed classes of aromatic carboxylic monomers, the aromatic may be represented by a benzene ring or a naphthalene ring.

These patent disclosures, like the prior art generally, fail to appreciate that the introduction of compatibilizer additives can cause further problems, such as the formation of unwanted byproducts. Therefore, in the pursuit of satisfactory polyamide-polyester barrier blends, there continues to be a need for improved polyamide-compatible polyester resins.

### SUMMARY OF THE INVENTION

Accordingly, it is an object of the present invention to provide polyethylene terephthalate polymers that possess exceptional compatibility with polyamide polymers.

It is a further object of the present invention to provide superior polyamide-polyester barrier blends.

It is a further object of the present invention to provide polyamide-polyester barrier blends having excellent clarity characteristics.

It is a further object of the present invention to provide polyamide-polyester barrier blends having excellent color characteristics.

It is a further object of the present invention to provide polyamide-polyester barrier blends that can be used to make packaging that provides extended shelf life.

It is a further object of the present invention to provide polyamide-polyester beverage bottles that possess superior barrier properties as compared to conventional polyester beverage bottles.

It is a further object of the present invention to provide polyamide-polyester beverage bottles that possess comparable clarity and organoleptic properties to those of conventional polyester beverage bottles.

It is a further object of the present invention to provide polyamide-polyester articles, such as beverage bottles, that can be cost-effectively recycled with no negative impact on the polyester recycling stream.

It is a further object of the present invention to provide improved methods for making these improved polyamide-polyester barrier blends.

It is a further object of the present invention to provide improved methods for making copolyester resins that are suitable for compatibilized blending with polyamide polymers.

It is a further object of the present invention to provide cost-effective methods of recycling polyamide-polyester articles (e.g., containers).

It is a further object of the present invention to include antioxidants in polyamide-polyester polymer blends (i.e., an upstream solution) to facilitate recycling of spent polyester bottles and polyamide-containing polyester bottles (i.e., a downstream problem).

The foregoing, as well as other objectives and advantages of the invention and the manner in which the same are accomplished, is further specified within the following detailed description.

### BRIEF DESCRIPTION OF THE DRAWINGS

FIG. 1 depicts the chemical structure and chemical abstract service (CAS) number of dimethyl sulfoisophthalate sodium salt (DMSIP-Na).

FIG. 2 depicts the chemical structure and chemical abstract service (CAS) number of sulfoisophthalic acid sodium salt (sIPA-Na).

FIG. 3 depicts theoretical carbonation loss for carbonated soft drink (CSD) bottles.

FIG. 4 depicts the shelf-life improvement of polyester carbonated soft drink bottles enhanced with nylon-MXD6 polyamide polymers.

FIG. 5 depicts the bottle sidewall haze, as measured on 16-ounce (˜500-milliliter) bottles, for various blends of polyethylene terephthalate polymers and nylon-MXD6 polyamide polymers.

FIG. 6 depicts L* values, as measured on 16-ounce (˜500-milliliter) bottles, for the polyamide-compatible polyethylene terephthalate polymers of the present invention as blended with various weight fractions of nylon-MXD6 polyamide polymers.

FIG. 7 depicts b* values, as measured on 16-ounce (˜500-milliliter) bottles, for the polyamide-compatible polyethylene terephthalate polymers of the present invention as blended with various weight fractions of nylon-MXD6 polyamide polymers.

FIG. 8 depicts the oligomer distribution in various polyethylene terephthalate polymers as measured by high performance liquid chromatography (HPLC).

FIGS. 9-11 illustrate how antioxidants can reduce the degradation of polyamide polymers during the recycling of nylon-containing polyester containers.

### DETAILED DESCRIPTION

In one aspect, the invention embraces polyamide-compatible polyethylene terephthalate resins that are useful in forming polyamide-polyester barrier blends possessing improved gas barrier, clarity, and organoleptic properties.

In this regard, the polyamide-compatible polyethylene terephthalate resins of the present invention are composed of about a 1:1 molar ratio of a terephthalate component and a diol component (i.e., a terephthalate moiety and a diol moiety). The terephthalate component is typically either a diacid component, which includes mostly terephthalic acid, or a diester component, which includes mostly dimethyl terephthalate. The diol component comprises mostly ethylene glycol.

The terephthalate component typically includes between about 0.1 and 2.0 mole percent sulfonated organic compound (e.g., between about 0.2 and 1.5 mole percent, such as 0.5 and 1.5 mole percent). In some circumstances, such as where the polyamide-compatible polyethylene terephthalate polymers are to be blended with higher fractions of polyamide polymers, higher concentrations of the sulfonated organic compound may be desirable (e.g., between about 1.0 and 2.0 mole percent). More typically, the terephthalate component includes between about 0.2 and 1.0 mole percent sulfonated organic compound (e.g., between about 0.25 and 0.75 mole percent or between about 0.5 and 1.0 mole percent).

The sulfonated organic compound may be employed in both aromatic and aliphatic forms. Organic sulfonic acids are especially suitable. Such organic sulfonic acids are typically available in less reactive salt form (i.e., neutralized). In this regard, those having ordinary skill in the art will appreciate that neutralized organic sulfonic acids (e.g. those including, without limitation, sodium, lithium, potassium, or magnesium atoms), are more stable.

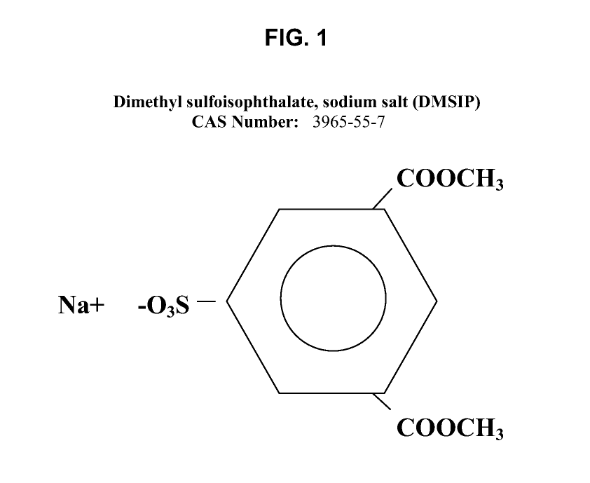

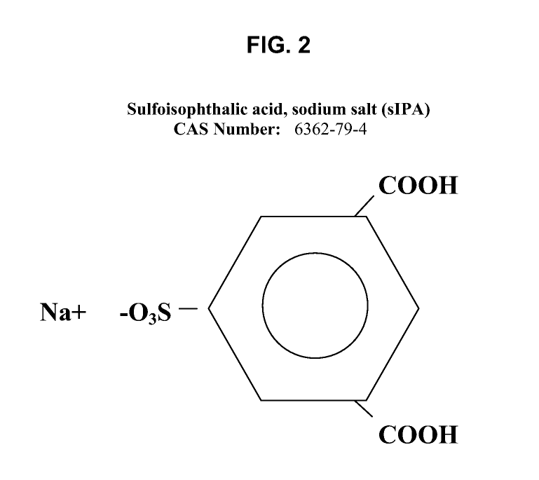

Sulfonated isophthalate derivatives—particularly dimethyl sulfoisophthalate (DMSIP) and sulfoisophthalic acid (sIPA)—are especially effective sulfonated organic compounds. Those having ordinary skill in the art will appreciate that these sulfonated isophthalate derivatives (i.e., ionomeric sulfonated isophthalate derivatives) are typically employed in their salt form (e.g., dimethyl sulfoisophthalate sodium salt). See FIGS. 1 and 2. Esterified sulfonated aromatic compounds, like DMSIP, are likewise favored.

More generally, exemplary sulfonated isophthalate derivatives according to the present invention may be represented by the structure (below), wherein R¹ and R² independently include hydrogen, alkyl radicals, or radicals of the formula CₙH₂ₙOH:

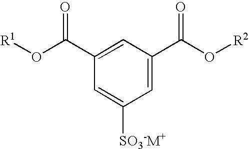

Those having ordinary skill in the art will appreciate that derivatives represented by this structure (above) featuring radical or radicals of the formula CₙH₂ₙOH represent a diol-esterified ionomeric sulfonated isophthalate derivative. The esterified form of the foregoing structure (above) facilitates the introduction of ionomeric sulfonated isophthalate derivatives into the polyethylene terephthalate precursors.

In one embodiment, such polyethylene terephthalate copolymers are composed of about a 1:1 molar ratio of a diacid component and a diol component, wherein the diacid component includes a sulfonated organic compound, but mostly terephthalic acid (e.g., 90-98 mole percent).

In another embodiment, such polyethylene terephthalate copolymers are composed of about a 1:1 molar ratio of a diester component and a diol component, wherein the diester component includes a sulfonated organic compound, but mostly dimethyl terephthalate (e.g. 90-98 mole percent).

In either embodiment, the diol component includes mostly ethylene glycol (e.g., 90 mole percent or more).

In another aspect, the invention embraces improved barrier blends formed from polyamide polymers and the aforementioned polyamide-compatible polyethylene terephthalate resins. The polyamide-polyester barrier blends of the present invention possess excellent barrier, clarity, and organoleptic properties, and are especially useful for packaging (e.g., containers, sheets, and films).

These polyamide-polyester barrier blends are achieved by compounding polyamide polymers with the polyamide-compatible polyethylene terephthalate polymers of the present invention. The polyamide-polyester barrier blends of the present invention can include up to 30 weight percent polyamide polymers. In this regard, the polyamide-polyester barrier blends typically include one or more kinds of polyamide polymers compounded with polyester polymers consisting essentially of the polyamide-compatible polyethylene terephthalate polymers. That is, the polyamide—polyester barrier blends of the present invention do not require—but certainly can include—more than one kind of polyester to achieve a compatibilized blend of polyamide and polyester polymers.

Those having ordinary skill in the art will appreciate that oxygen and carbon dioxide barrier increases with the polyamide fraction. Accordingly, in packaging applications where barrier properties are more important than color and clarity, the polyamide-polyester barrier blends should include at least about 5 or 10 weight percent polyamide polymers. Indeed, for some uses the polyamide-polyester barrier blends may include at least about 15 weight percent polyamide polymers.

Those having ordinary skill in the art will appreciate that packaging formed from polyamide-polyester blends tend to become more noticeably yellow and hazy with increasing polyamide fraction. For most container applications (e.g., bottles and perhaps trays), therefore, blending less than about 20 weight percent polyamide polymers (e.g., between about 0.5 and 15 mole percent, such as between about 1 and 10 mole percent) with at least about 80 weight percent polyamide-compatible polyethylene terephthalate polymers will provide satisfactory performance.

To be sure, color and clarity are important parameters for beverage bottles, and so for these applications the polyamide-polyester barrier blends of the present invention typically include less than about 10 weight percent polyamide polymers (e.g., between about 3 and 10 weight percent), more typically between about 1 and 5 weight percent polyamide polymers (e.g., less than about 5 weight percent, such as between about 2 and 4 weight percent polyamide polymers or between about 1.5 and 3 weight percent polyamide polymers). For container applications in which color and clarity are substantially more important than barrier properties, the polyamide-polyester barrier blends may include between about 0.5 and 1.5 weight percent polyamide polymers and at least about 95 weight percent polyamide-compatible polyethylene terephthalate polymers.

Those having ordinary skill in the art will understand that, with respect to the polyamide-polyester barrier blends of the present invention, the intended packaging application will largely determine the respective polyamide and polyester fractions.

Exemplary polyamides for use in the present polyamide-polyester barrier blends include, without limitation, nylon-66, nylon-6, nylon-612, nylon-11, nylon-12 and nylon-46, and nylon-MXD6. Nylon-MXD6, which is available from Mitsubishi Gas Chemical Company, Inc. (New York, N.Y.), is especially suitable. Nylon-MXD6 is a semi-crystalline polyamide that possesses thermal and physical properties similar to polyethylene terephthalate. Nylon-MXD6 also exhibits excellent gas barrier properties.

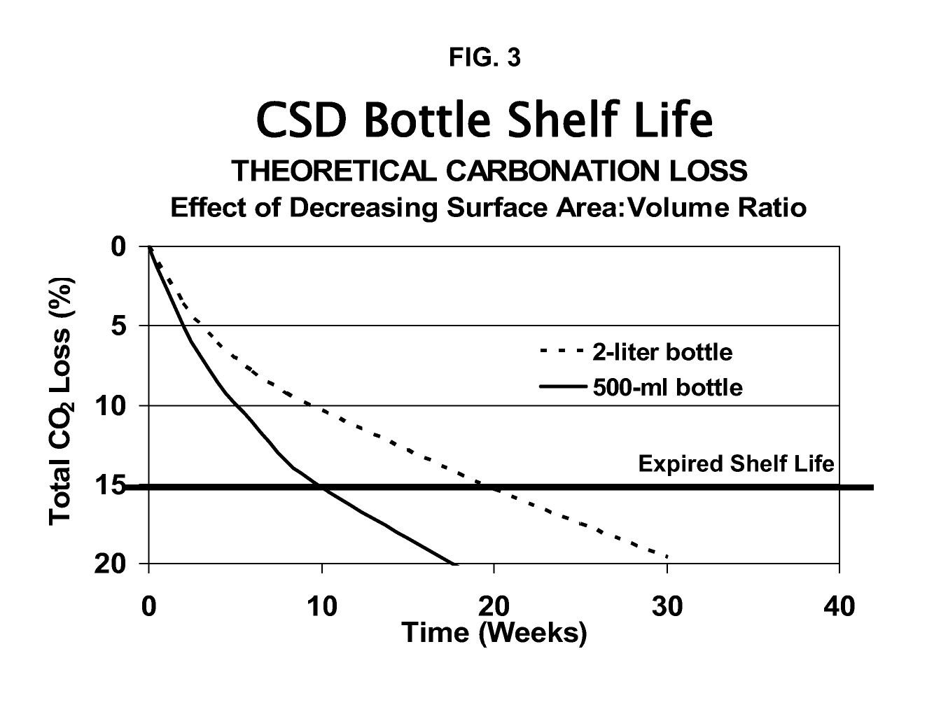

FIG. 3 depicts the theoretical carbonation loss of a carbonated soft drink (CSD) bottle over time. Carbonation loss is directly related to shelf life. FIG. 3 shows that percent carbonation loss occurs faster with smaller containers. This is a function of the increased surface area to volume ratio in the smaller container.

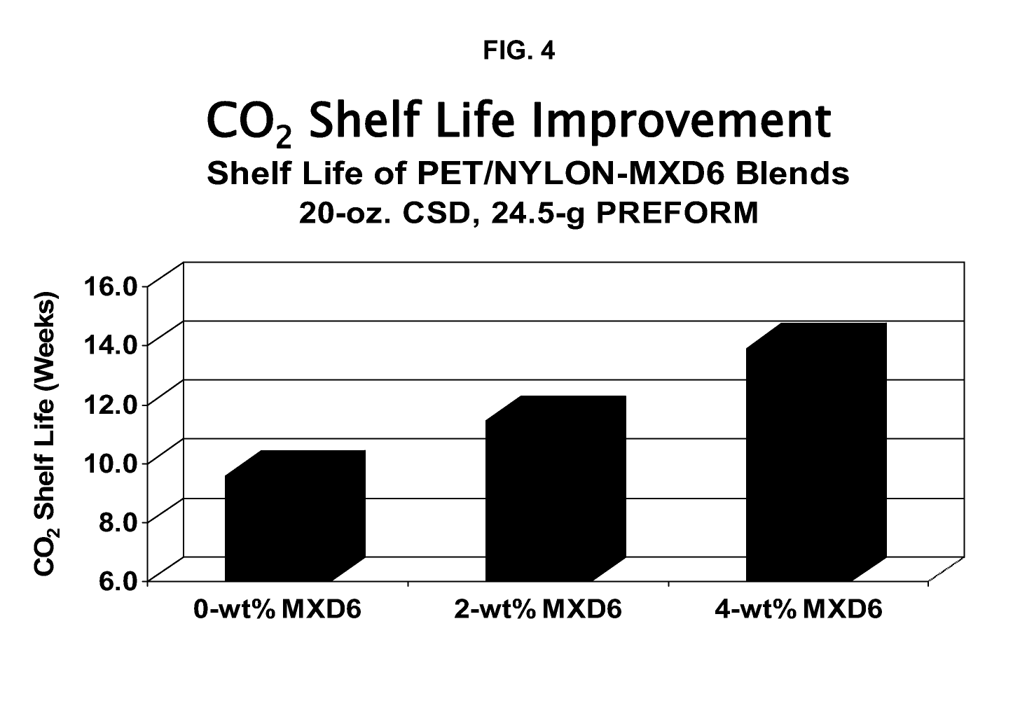

FIG. 4 depicts the improvement in shelf life (as measured by CO₂ permeability) of 20-ounce (˜600-milliliter) carbonated soft drink bottles. These CSD bottles are made from polyethylene terephthalate resins blended with 0 (i.e., control polyester), 2, or 4 weight percent nylon-MXD6 polyamide polymers. The improvement in gas barrier properties over the control, as measured by product shelf life, are more than two weeks with a 2 weight percent blend of nylon-MXD6 polyamide polymers, and over a month with a 4 weight percent blend of nylon-MXD6 polyamide polymers.

Accordingly, in one embodiment that is especially useful for carbonated soft drink bottles, the polyamide-polyester barrier blends include between about 1 and 5 weight percent nylon-MXD6 polyamide polymers (i.e., nylon-MXD6) and between about 99 and 95 weight percent polyamide-compatible polyethylene terephthalate polymers that have sulfoisophthalate modification in an amount between about 0.1 and 2.0 mole percent (e.g., between about 0.2 and 1.5 mole percent of ionomeric sulfonated isophthalate derivatives).

In another such embodiment, the polyamide-polyester barrier blends include between about 2 and 4 weight percent nylon-MXD6 polyamide polymers and between about 98 and 95 weight percent polyamide-compatible polyethylene terephthalate polymers that have sulfoisophthalate modification in an amount between about 0.2 and 1.0 mole percent (e.g., 0.5 mole percent of ionomeric sulfonated isophthalate derivatives).

The polyamide-polyester containers of the present invention can substantially extend shelf life typically provided by conventional polyester containers (i.e., about ten weeks or so). As compared with an otherwise identical container formed from conventional homopolymer polyester, the present polyamide-polyester containers provide superior barrier properties, yet possess comparable clarity and organoleptic properties. Those having ordinary skill in the art will appreciate that as used herein, the term “conventional homopolymer polyester” is intended to embrace not only pure homopolyesters but also copolyesters that include low amounts of comonomer substitution (e.g. less than about 5 mole percent modification).

For example, polyamide-polyester containers of the present invention possess at least about 15 percent better oxygen and carbon dioxide barrier properties as compared with otherwise identical containers formed from conventional polyethylene terephthalate, typically between about 20 and 75 percent better oxygen and carbon dioxide barrier properties (e.g., more than about a 50 percent improvement). Moreover, as the polyamide-compatible polyethylene terephthalate polymers of the present invention are blended with increasing weight fractions of polyamide polymers, the barrier properties of the resulting polyamide-polyester containers demonstrate increasing oxygen and carbon dioxide barrier properties. At higher polyamide fractions, the polyamide-polyester containers of the present invention can possess at least about 100 percent better oxygen and carbon dioxide barrier properties as compared with otherwise identical containers formed from homopolymer polyethylene terephthalate—and with some polyamide-polyester blends, more than 200 percent better barrier.

Those having ordinary skill in the art will understand that for many applications (e.g., preforms and bottles) barrier resins must yield containers exhibiting low haze. In this regard, it has been discovered that modifying polyethylene terephthalate polymers with a sulfonated organic compound, such as DMSIP or sIPA, substantially reduces sidewall haze. For example, 16-ounce (˜500-milliliter) carbonated soft drink bottles formed from the polyamide-polyester barrier blends of the present invention usually possess less than about 8 percent sidewall haze, typically less than about 6 percent sidewall haze, and more typically between about 3 and 4 percent sidewall haze. Sidewalls for 16-ounce (˜500-milliliter) and 20-ounce (˜600-milliliter) carbonated soft drink bottles are, for example, about 0.010-0.012 inch (about 0.25-0.30 mm). Likewise, sidewalls for two-liter carbonated soft drink bottles are typically less than 0.014 inch (0.35 mm).

More generally, the polyamide-polyester containers according to the present invention possess at least about 10 percent less sidewall haze—more typically at least about 20 or 30 percent less sidewall haze—as compared with otherwise identical containers formed from the same relative weight fractions of polyamide and homopolymer polyethylene terephthalate (i.e., including only low amounts of comonomer substitution, if any). Indeed, the polyamide-polyester containers according to the present invention may possess at least about 40 or 50 percent less sidewall haze as compared with otherwise identical containers formed from the same relative weight fractions of polyamide and homopolymer polyethylene terephthalate.

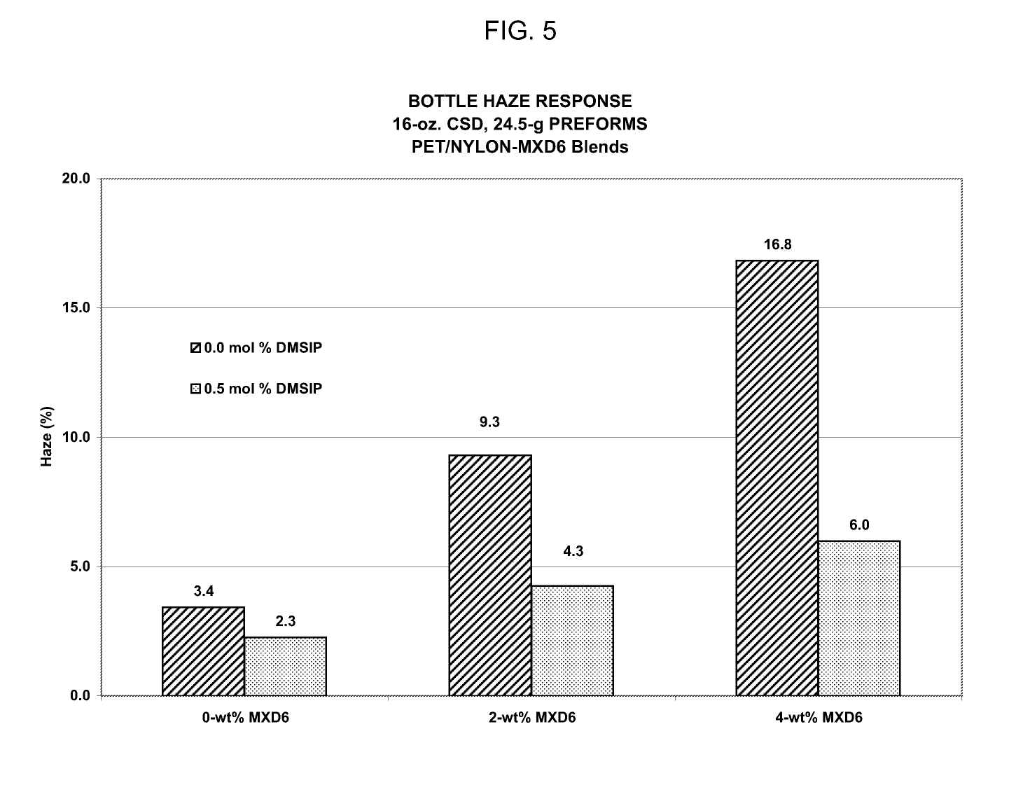

As previously discussed, however, blending conventional polyethylene terephthalate polyester with a polyamide barrier agent may result in unsatisfactory packaging. For example, merely mixing conventional polyethylene terephthalate with nylon-MXD6 polyamide polymers leads to unacceptably hazy bottles. FIG. 5 depicts the bottle sidewall haze measurements after blending both conventional and DMSIP-modified polyethylene terephthalate resins with 0 (i.e., control polyester), 2, or 4 weight percent of nylon-MXD6 polyamide polymers. Bottle sidewall haze was measured in 16-ounce (˜500-milliliter) carbonated soft drink bottles formed from the resin blends and having a sidewall thickness of 0.010-0.012 inch (about 0.25-0.30 mm).

With respect to the conventional polyethylene terephthalate resins, bottle sidewall haze increased 6 percent in the bottles blended with 2 weight percent nylon-MXD6 polyamide polymers as compared with the control polyester; bottle sidewall haze increased more than 12 percent in the bottles blended with 4 weight percent nylon-MXD6 polyamide polymers as compared with the control polyester.

In contrast, with respect to the DMSIP-modified polyethylene terephthalate resins, there was substantially less increase in bottle sidewall haze with increasing fractions of nylon-MXD6 polyamide polymers. Moreover, at the same relative weight fractions of nylon-MXD6 polyamide polymers, the DMSIP-modified polyethylene terephthalate resins demonstrated substantially less bottle sidewall haze as compared with the conventional polyethylene terephthalate resins. For instance, at 2 weight percent nylon-MXD6 polyamide polymers, the DMSIP-modified polyethylene terephthalate resins possessed 5 percent less bottle sidewall haze as compared with the conventional polyethylene terephthalate resins; at 4 weight percent nylon-MXD6 polyamide polymers, the DMSIP-modified polyethylene terephthalate resins possessed over 10 percent less bottle sidewall haze as compared with the conventional polyethylene terephthalate resins.

Those having ordinary skill in the art will further understand that barrier resins must yield containers possessing excellent color (i.e., not too dark or yellow). In contrast to prior polyamide-polyester blends, which tend to be excessively yellow, the polyamide-polyester barrier blends of the present invention possess excellent color characteristics.

Color differences are commonly classified according to the L*a*b* color space of the Commission Internationale l'Eclairage (CIE). The three components of this system consist of L*, which describes luminosity on a scale of 0-100 (i.e., 0 is black and 100 is white), a*, which describes the red-green axis (i.e., positive values are red and negative values are green), and b*, which describes the yellow-blue axis (i.e., positive values are yellow and negative values are blue). For characterizing polyamide-polyester barrier blends, as well as for their constituent polyester resins, L* and b* values are of particular interest.

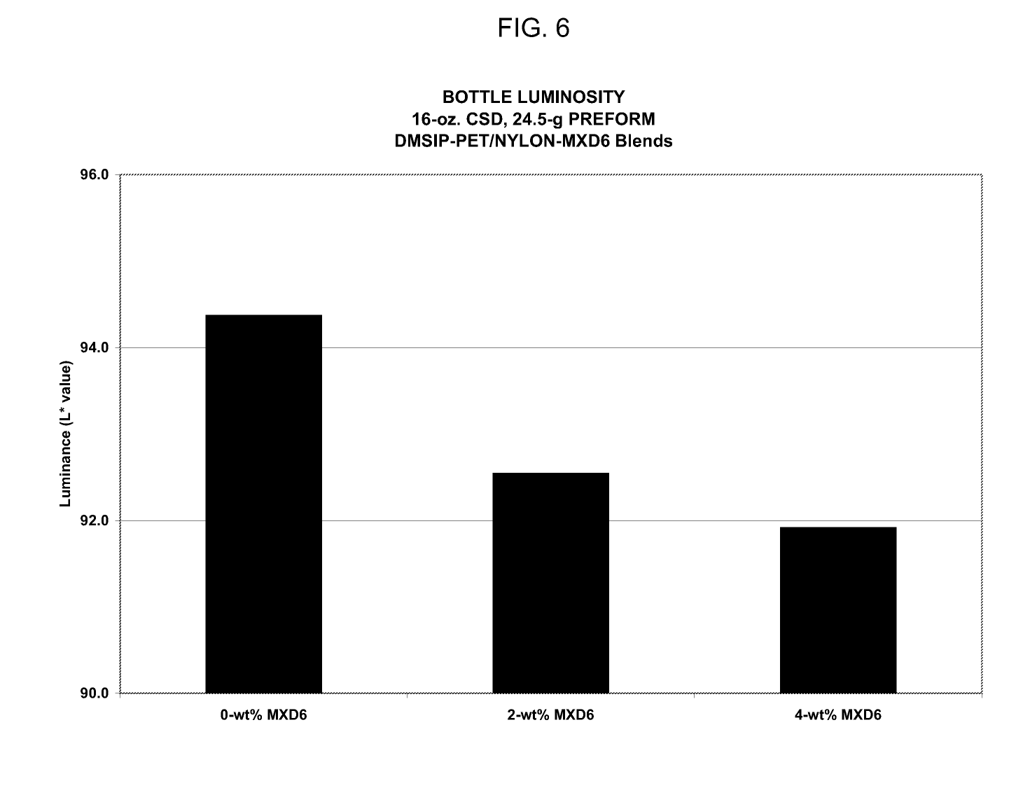

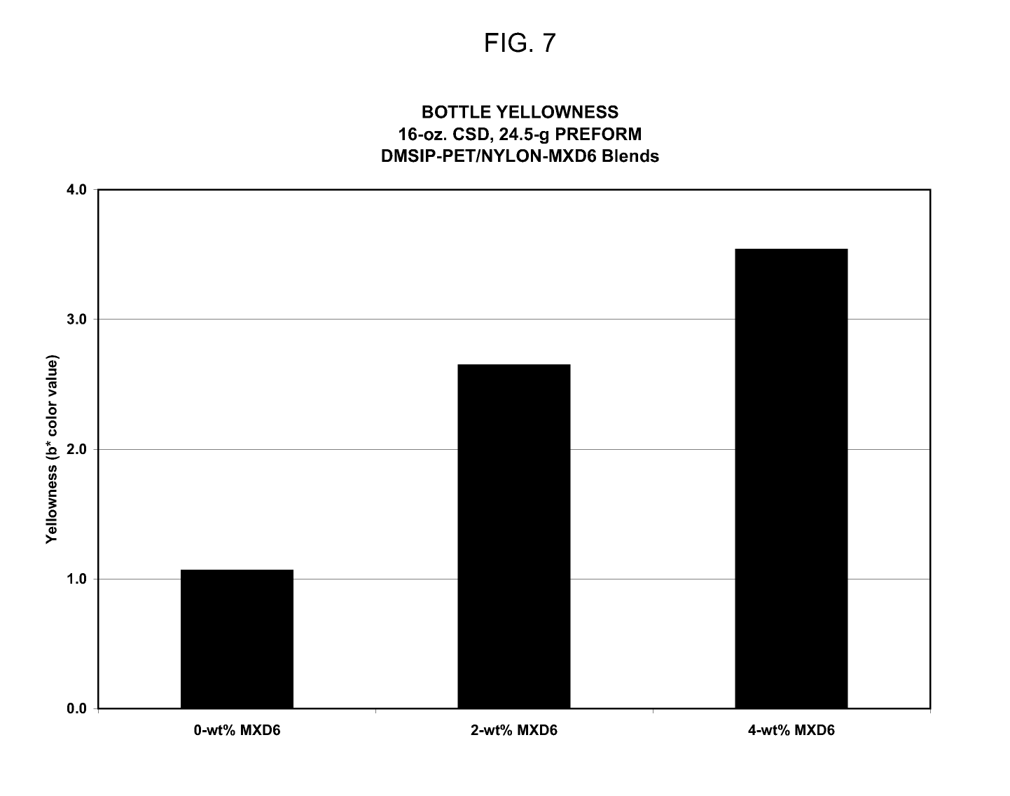

The polyamide-polyester barrier blends of the present invention can be injection molded or otherwise formed into articles, such as preforms. Polyamide-polyester preforms containing between about 2 and 4 weight percent nylon-MXD6 can possess L* values of 75 or more and b* color values of 5 or less (as measured directly on the preforms). Similarly, polyamide-polyester bottles stretch-blow molded from such preforms can possess L* values of 90 or more and b* color values of 4 or less (e.g. 2 or less) as measured directly on the sidewalls of such bottles. As noted, 16-ounce (˜500-milliliter), 20-ounce (˜600-milliliter), and two-liter carbonated soft drink bottles typically possess sidewalls thicknesses of about 0.010-0.014 inch (about 0.25-0.35 mm). In general, increasing polyamide fractions in the polyamide-polyester barrier blends lowers L* values and raises b* color values. See FIGS. 6 and 7.

Those having ordinary skill in the art will appreciate that measuring color in preforms and bottles can be awkward. Thus, preforms and bottles can be formed into standard test plaques to facilitate comparative color measurements. In this regard, polyamide-polyester articles according to the present invention (e.g., preforms and bottles) may be ground, melted at 280° C., and then injected into a cold mold to form standard, three-millimeter (3 mm) non-crystalline polyester test plaques. Color values for such articles may then be conveniently measured on these standard test plaques, which are about the same thickness as CSD bottle preforms (e.g., 20-oz. bottle preforms are about 3.5 millimeters thick and two-liter preforms are about 4.0 millimeters thick).

The CIE L*a*b* color space values for polyamide-polyester articles of the present invention may be reported based on color measurements taken upon these standard test plaques. Such articles may include, without limitation, films, sheets, fibers, preforms, bottles, and even pellets. In this regard, CIE L*a*b* color space values for the three-millimeter, non-crystalline polyamide-polyester test plaques may be determined using a HunterLab LabScan XE spectrophotometer (illuminant/observer: D65/10′; diffuse 8° standard; transmittance port). Those having ordinary skill in the art will appreciate that non-crystalline polyamide-polyester plaques are essentially transparent and so are typically measured by transmittance.

If standard test plaques are formed from polyamide-polyester preforms, bottles, sheets, or films, the constituent polymers may possess unfavorable heat histories (i.e., forming operations may somewhat degrade the color of the constituent polyamide and polyester polymers). By way of illustration, it has been observed that injection molding preforms from crystalline polyethylene terephthalate pellets (and thereafter forming standard test plaques) can introduce some yellowing (i.e., the b* color value increases slightly). As compared with polyethylene terephthalate polymers, polyamide polymers have been observed to be more susceptible to heat-induced color degradation.

Accordingly, polyamide-polyester articles of the present invention (e.g., films, sheets, preforms, bottles, and crystalline pellets) ought to possess a L* value of more than about 55 (e.g., more than about 60) and a b* color value of less than about 6 (e.g., less than about 5) as classified by the CIE L*a*b* color space and as measured upon standard three-millimeter test plaques. It would be even more desirable for polyamide-polyester articles of the present invention to possess a L* value of more than about 70 (e.g. more than about 75 or 80) and/or a b* color value of less than about 3 (e.g., less than about 2) as classified by the CIE L*a*b* color space and as measured upon standard three-millimeter test plaques. As reported herein, CIE L*a*b* color space values that are based upon color measurements taken upon these three-millimeter non-crystalline test plaques will be so identified.

Similarly, polyamide-polyester articles of the present invention preferably possess b* color values of less than about 4 (e.g., between about −3 and 2) as classified by the CIE L*a*b* color space and as measured directly upon such polyamide-polyester articles. As reported herein, CIE L*a*b* color space values that are based upon color measurements taken directly from articles formed from the polymer blend will be so identified.

As noted previously, the CIE L*a*b* color space is also of interest in characterizing the polyamide-compatible polyethylene terephthalate polymers of the present invention. In this regard, the present polyamide-compatible polyethylene terephthalate polymers possess an amorphous L* value (i.e., luminosity) of more than about 50 and an amorphous b* color value of less than about 5. The polyamide-compatible polyethylene terephthalate polymers typically possess an amorphous L* value of more than about 60 (e.g., more than about 65). Moreover, the polyamide-compatible polyethylene terephthalate polymers typically possess an amorphous b* color value of less than about 4 (e.g. less than about 2). In this regard, the amorphous b* color value is evaluated for uncolored resins (i.e., not including colorants).

Those having ordinary skill in the art will understand that polyester processing often affects color. For instance, the luminosity of polyethylene terephthalate typically increases upon crystallization and solid state polymerization (i.e., the L* color value increases slightly). Polyester bottles formed only from the polyamide-compatible polyethylene terephthalate polymers of the present invention (i.e., without any nylon) possess L* values of 94 or more and b* color values of 1 or less as measured directly on the polyester bottles. Thus, as used herein, the terms “amorphous L* value” and “amorphous b* color value” refer to measurements based on uncolored, amorphous pellets. Similarly, the terms “crystalline L* value” and “crystalline b* color value” refer to measurements based on uncolored, crystalline pellets. The CIE L*a*b* color space values for such amorphous and crystalline polyethylene terephthalate resins may be determined using a HunterLab LabScan XE spectrophotometer.

Unless otherwise indicated (e.g., measurements taken on test plaques or articles, such as preforms or bottles), the CIE L*a*b* color space values reported herein for the polyamide-compatible polyethylene terephthalate polymers of the present invention relate to amorphous pellets (i.e., “amorphous L* value” and “amorphous b* color value”). It will be noted, however, that polyethylene terephthalate bottle resins are most often commercially available in the form of crystalline pellets. Thus, color measurements of crystallized polyethylene terephthalate pellets are sometimes more convenient. In this regard, it has been observed that with respect to polyamide-compatible polyethylene terephthalate polymers of the present invention, amorphous b* color values and crystalline b* color values are comparable (i.e., crystallizing amorphous pellets does not seem to affect significantly the measured b* color value of the pellets).

Test procedures (e.g., standards and calibrations) appropriate for measuring color properties of polyester in various forms (e.g., amorphous pellets, crystalline pellets, non-crystalline test plaques, preforms, and bottles) are readily available to and within the understanding of those having ordinary skill in the art. As used herein, the term “pellets” is used generally to refer to chips, pellets, and the like.

In yet another aspect, the invention embraces methods of making improved polyamide-compatible polyethylene terephthalate resins. The invention likewise embraces methods of making improved polyamide-polyester barrier blends.

Those having ordinary skill in the art will appreciate that the step of reacting a terephthalate component and a diol component typically means reacting either a diacid component (e.g. mostly terephthalic acid) or a diester component (e.g., mostly dimethyl terephthalate) with ethylene glycol to form polyethylene terephthalate precursors. Prior to the introduction of the sulfonated organic compound, these polyethylene terephthalate precursors typically include less than about 10 mole percent comonomer substitution (e.g., between about 3 and 8 mole percent comonomer), typically less than about 5 mole percent comonomer substitution (e.g., about 3 or 4 mole percent comonomer). Modification of the terephthalate and diol components via selective comonomer substitution is further discussed herein.

The sulfonated organic compound is introduced into the polyethylene terephthalate precursors rather than at charge. The sulfonated organic compound reacts with the polyethylene terephthalate precursors to yield modified polyethylene terephthalate precursors. Thereafter, the modified polyethylene terephthalate precursors are polymerized via melt phase polycondensation to form polyamide-compatible polyethylene terephthalate polymers.

The melt phase polymerization typically continues until the polyamide-compatible polyethylene terephthalate polymers achieve an intrinsic viscosity of at least about 0.45 dL/g (e.g., between about 0.45 and 0.75 dL/g) and typically between about 0.5 and 0.8 dL/g (e.g., between about 0.55 and 0.70 dL/g).

The method typically includes subsequent solid state polymerization of the polyamide-compatible polyethylene terephthalate polymers to an intrinsic viscosity of at least about 0.60 dL/g (e.g., between about 0.65 and 1.0 dL/g) and typically between about 0.7 and 0.85 dL/g (e.g. about 0.75 dL/g). Solid state polymerization typically proceeds at temperatures above about 190° C. (e.g., about 200° C. or more).

Alternatively, the polyamide-compatible polyethylene terephthalate polymers may polymerized via melt-phase polycondensation (without solid state polymerization) to achieve an intrinsic viscosity greater than about 0.8 dL/g. Thereafter, the polyamide-compatible polyethylene terephthalate polymers may be subjected to crystallization.

Those having ordinary skill in the art will appreciate that most commercial polyethylene terephthalate polymers are, in fact, modified polyethylene terephthalate polyesters. Indeed, the polyamide-compatible polyethylene terephthalate resins described herein are typically modified polyethylene terephthalate polyesters. In this regard, the modifiers in the terephthalate component and the diol component are typically randomly substituted in the resulting polyester composition.

Those having ordinary skill in the art recognize that other kinds of additives can be incorporated into the modified polyethylene terephthalate polymers of the present invention. Such additives include, without limitation, preform heat-up rate enhancers, friction-reducing additives, UV absorbers, inert particulate additives (e.g., clays or silicas), colorants, branching agents, oxygen barrier agents, carbon dioxide barrier agents, oxygen scavengers, flame retardants, crystallization control agents, acetaldehyde reducing agents, impact modifiers, catalyst deactivators, melt strength enhancers, anti-static agents, lubricants, chain extenders, nucleating agents, solvents, fillers, and plasticizers. Moreover, as discussed herein, including antioxidants in the modified polyethylene terephthalate polymers reduces the negative impact that such polyamide-polyester barrier blends can have upon polyethylene terephthalate recycling streams. This, in turn, facilitates cost-effective recycling of polyamide-polyester barrier blends.

As used herein, the term “comonomer” is intended to include monomeric and oligomeric modifiers (e.g. polyethylene glycol).

As used herein, the term “diol component” refers primarily to ethylene glycol, although other diols may be used as well.

The term “terephthalate component” broadly refers to diacids and diesters that can be used to prepare polyethylene terephthalate. In particular, the terephthalate component mostly includes either terephthalic acid or its dialkyl ester (i.e., dimethyl terephthalate), but can include diacid and diester comonomers as well. In other words, the “terephthalate component” is either a “diacid component” or a “diester component.”

The term “diacid component” refers somewhat more specifically to diacids (e.g., terephthalic acid) that can be used to prepare polyethylene terephthalate via direct esterification. The term “diacid component,” however, is intended to embrace relatively minor amounts of diester comonomer (e.g., mostly terephthalic acid and one or more diacid modifiers, but optionally with some diester modifiers, too).

Similarly, the term “diester component” refers somewhat more specifically to diesters (e.g., dimethyl terephthalate) that can be used to prepare polyethylene terephthalate via ester exchange. The term “diester component,” however, is intended to embrace relatively minor amounts of diacid comonomer (e.g., mostly dimethyl terephthalate and one or more diester modifiers, but optionally with some diacid modifiers, too).

The diol component can include diols besides ethylene glycol; polyalkylene glycols such as polyethylene glycol; 1,3-propane diol; 1,4-butane diol; 1,5-pentanediol; 1,6-hexanediol; propylene glycol; 1,4-cyclohexane dimethanol; neopentyl glycol; 2-methyl-1,3-propanediol; 2,2,4,4-tetramethyl-1,3-cyclobutanediol; adamantane-1,3-diol, 3,9-bis(1,1-dimethyl-2-hydroxyethyl)-2,4,8,10-tetraoxaspiro[5,5]undecane; and isosorbide).

Alternatively, the terephthalate component, in addition to terephthalic acid or its dialkyl ester (i.e., dimethyl terephthalate), can include modifiers such as isophthalic acid or its dialkyl ester (i.e., dimethyl isophthalate); 2,6-naphthalene dicarboxylic acid or its dialkyl ester (i.e., dimethyl 2,6 naphthalene dicarboxylate); adipic acid or its dialkyl ester (i.e., dimethyl adipate); succinic acid, its dialkyl ester (i.e., dimethyl succinate), or its anhydride (i.e., succinic anhydride); or one or more functional derivatives of terephthalic acid. Other exemplary diacid or diester comonomers modifiers include phthalic acid, phthalic anhydride, biphenyl dicarboxylic acid, cyclohexane dicarboxylic acid, anthracene dicarboxylic acid, adamantane 1,3-dicarboxylic acid, glutaric acid, sebacic acid, and azelaic acid.

In general, diacid comonomer should be employed when the terephthalate component is mostly terephthalic acid (i.e., a diacid component), and diester comonomer should be employed when the terephthalate component is mostly dimethyl terephthalate (i.e., a diester component).

It will be further understood by those having ordinary skill in the art that to achieve the polyester composition of the present invention a molar excess of the diol component is reacted with the terephthalate component (i.e., the diol component is present in excess of stoichiometric proportions).

In reacting a diacid component and a diol component via a direct esterification reaction, the molar ratio of the diacid component and the diol component is typically between about 1.0:1.0 and 1.0:1.6. Moreover, the diacid component typically includes at least 90 mole percent terephthalic acid, and more typically at least 95 mole percent terephthalic acid (e.g., between about 96 and 98 mole percent terephthalic acid); the diol component typically includes at least 90 mole percent ethylene glycol, and more typically at least 95 mole percent ethylene glycol (e.g., between about 96 and 98 mole percent ethylene glycol).

Alternatively, in reacting a diester component and a diol component via an ester interchange reaction, the molar ratio of the diester component and the diol component may exceed 1.0:2.0 but is typically between about 1.0:1.6 and 1.0:2.0. Moreover, the diester component typically includes at least 90 mole percent dimethyl terephthalate, and more typically at least 95 mole percent dimethyl terephthalate (e.g., between about 96 and 98 mole percent dimethyl terephthalate); the diol component typically includes at least 90 mole percent ethylene glycol, and more typically at least 95 mole percent ethylene glycol (e.g., between about 96 and 98 mole percent ethylene glycol).

The diol component usually forms the majority of terminal ends of the polymer chains and so is present in the resulting polyester composition in slightly greater fractions. This is what is meant by the phrases “about a 1:1 molar ratio of a terephthalate component and a diol component,” “about a 1:1 molar ratio of a diacid component and a diol component,” and “about a 1:1 molar ratio of a diester component and a diol component,” each of which is used herein to describe the polyester compositions of the present invention.

As used herein, the term “intrinsic viscosity” is the ratio of the specific viscosity of a polymer solution of known concentration to the concentration of solute, extrapolated to zero concentration. Intrinsic viscosity, which is widely recognized as standard measurements of polymer characteristics, is directly proportional to average polymer molecular weight. See, e.g., Dictionary of Fiber and Textile Technology, Hoechst Celanese Corporation (1990); Tortora & Merkel, Fairchild's Dictionary of Textiles (7^{th} Edition 1996).

Intrinsic viscosity can be measured and determined without undue experimentation by those of ordinary skill in this art. For the intrinsic viscosity values described herein, the intrinsic viscosity is determined by dissolving the polyester in orthochlorophenol (OCP), measuring the relative viscosity of the solution using a Schott Autoviscometer (AVS Schott and AVS 500 Viscosystem), and then calculating the intrinsic viscosity based on the relative viscosity. See, e.g. Dictionary of Fiber and Textile Technology (“intrinsic viscosity”).

In particular, a 0.6-gram sample (+/−0.005 g) of dried polymer sample is dissolved in about 50 ml (61.0-63.5 grams) of orthochlorophenol at a temperature of about 105° C. Fibrous samples are typically cut into small pieces, whereas chip samples are ground. After cooling to room temperature, the solution is placed in the viscometer at a controlled, constant temperature, (e.g., between about 20° and 25° C.), and the relative viscosity is measured. As noted, intrinsic viscosity is calculated from relative viscosity.

Those having ordinary skill in the art will know that there are two conventional methods for forming polyethylene terephthalate. These methods are well known to those skilled in the art.

One method employs a direct esterification reaction using terephthalic acid and excess ethylene glycol. In this technique, the aforementioned step of reacting a terephthalate component and a diol component includes reacting terephthalic acid and ethylene glycol in a heated esterification reaction to form monomers and oligomers of (i) terephthalic acid and, optionally, diacid modifiers, and (ii) ethylene glycol and, optionally, diol modifiers. Water, as well, is formed as a byproduct.

To enable the esterification reaction to go essentially to completion, the water must be continuously removed as it is formed. Subsequently, the monomers and oligomers are catalytically polymerized via polycondensation (i.e., melt phase and/or solid state polymerization) to form polyethylene terephthalate polyester. During polycondensation, ethylene glycol is continuously removed to create favorable reaction kinetics.

The other method involves a two-step ester exchange reaction and polymerization using dimethyl terephthalate and excess ethylene glycol. In this technique, the aforementioned step of reacting a terephthalate component and a diol component includes reacting dimethyl terephthalate and ethylene glycol in a heated, catalyzed ester interchange reaction (i.e., transesterification) to form monomers of (i) dimethyl terephthalate and, optionally, diester modifiers, and (ii) ethylene glycol and, optionally, diol modifiers. Methanol, as well, is formed as a byproduct. In particular, dimethyl terephthalate and ethylene glycol yield bis(2-hydroxyethyl)-terephthalate monomers.

To enable the ester exchange reaction to go essentially to completion, methanol must be continuously removed as it is formed. The bis(2-hydroxyethyl)terephthalate intermediate monomer product is then catalytically polymerized via polycondensation (i.e., melt phase and/or solid state polymerization) to produce polyethylene terephthalate polymers. As noted, during polycondensation, ethylene glycol is continuously removed to create favorable reaction kinetics. The resulting polyethylene terephthalate polymers are substantially identical to the polyethylene terephthalate polymers resulting from direct esterification using terephthalic acid, albeit with some minor chemical differences.

In the present invention, the direct esterification reaction is preferred over the older, two-step ester exchange reaction. Direct esterification of terephthalic acid is not only more economical but often yields polyethylene terephthalate resins having better color.

Polyethylene terephthalate polyester may be produced in a batch process, where the product of the esterification or ester interchange reaction is formed in one vessel and then transferred to a second vessel for polymerization. The second vessel is agitated. Generally, the polymerization reaction is continued until the power used by the agitator reaches a level indicating that the polyester melt has achieved the desired intrinsic viscosity and, thus, the desired molecular weight. More commercially practicable, however, is to carry out the esterification or ester interchange reaction, and then the polymerization reaction, as a continuous process. The continuous production of polyethylene terephthalate results in greater throughput, and so is more typical in large-scale manufacturing facilities.

Those having ordinary skill in the art will appreciate that including catalysts increases the rates of esterification and polycondensation and, hence, the production of the polyethylene terephthalate resins. Catalysts, however, will eventually degrade the polyethylene terephthalate polymer. For example, degradation may include polymer discoloration (e.g., yellowing), acetaldehyde formation, or molecular weight reduction. To reduce these undesirable effects, stabilizing compounds can be employed to sequester (“cool”) the catalysts. The most commonly used stabilizers contain phosphorus, typically in the form of phosphates and phosphites.

Certain problems associated with the addition of stabilizer are addressed in U.S. Pat. No. 5,898,058 for a Method of Post-Polymerization Stabilization of High Activity Catalysts in Continuous Polyethylene Terephthalate Production, which discloses a method of stabilizing high activity polymerization catalysts in continuous polyethylene terephthalate production. This patent, which is commonly assigned with this application, is hereby incorporated entirely herein by reference.

Moreover, the aforementioned U.S. Pat. No. 6,599,596 for Methods of Post-Polymerization Injection in Continuous Polyethylene Terephthalate Production, discloses a process for the production of high quality polyethylene terephthalate polyester that improves upon the stabilizer-addition techniques disclosed by commonly-assigned U.S. Pat. No. 5,898,058.

In one embodiment, the method for making polyamide-compatible polyethylene terephthalate polymers employs the aforementioned direct esterification reaction using terephthalic acid and excess ethylene glycol. This method includes reacting (i) a diacid component comprising terephthalic acid and (ii) a diol component comprising ethylene glycol to form polyethylene terephthalate precursors. This latter reaction achieves polyethylene terephthalate precursors having an average degree of polymerization between about 2 and 10, typically between about 3 and 6.

Thereupon, the polyethylene terephthalate precursors are reacted with a sulfonated organic compound to yield modified polyethylene terephthalate precursors. The modified polyethylene terephthalate precursors are then polymerized via melt phase polycondensation to form polyamide-compatible polyethylene terephthalate polymers.

Those having skill in the polymer arts will appreciate that the direct esterification reaction using terephthalic acid and excess ethylene glycol begins under extremely acidic conditions. Moreover, certain sulfonated organic compounds can further acidify the esterification reaction. Such acidic conditions can cause the unwanted formation of diethylene glycol.

Those having ordinary skill in the art will appreciate that excess diethylene glycol causes a number of problems. For example, high diethylene glycol content (e.g., more than about 8 mole percent) (i) can adversely narrow the blow molding temperature range (i.e., shrinks the resin processing window); (ii) can disrupt bottle weight distribution (i.e., crystallization in the base); (iii) can suppress glass transition (T_{G}) temperature, thereby diminishing thermal stability; and (iv) can promote the formation of acetaldehyde, which degrades favorable organoleptic properties.

Therefore, it is suggested that the introduction of the sulfonated organic compound into the polyethylene terephthalate precursors be delayed until the polyethylene terephthalate precursors have a carboxyl end group concentration of less than about 1000 microequivalents per gram, typically less than about 900 microequivalents per gram (e.g., between about 300 and 900 microequivalents per gram), and more typically less than about 800 microequivalents per gram (e.g. between about 400 and 800 microequivalents per gram). In other words, at the time sulfonated organic compound is introduced to the esterification reaction, the carboxyl end group concentration of the esterification reaction is less than about 1000 microequivalents per gram (e.g., about 500 microequivalents per gram).

Moreover, to further control diethylene glycol such that the polyamide-compatible polyethylene terephthalate polymers include less than about 6 mole percent diethylene glycol content (e.g., less than 3 or 4 mole percent), a buffer (e.g. sodium acetate) may be introduced to the esterification reaction in an amount sufficient to control the acidity of the sulfonated organic compound. For example, if the polyamide-compatible polyethylene terephthalate polymers include DMSIP substitution, then sodium acetate may be introduced to the esterification reaction at 10 mole percent of the DMSIP mole fraction to control diethylene glycol formation. For effective results, the buffer is introduced to the esterification reaction prior to or concurrently with the initiation of the reaction between the sulfonated organic compound and the polyethylene terephthalate precursors.

By controlling the formation of diethylene glycol in these ways, the method according to the present invention provides polyamide-compatible polyethylene terephthalate polymers having less than about 6 mole percent diethylene glycol content—typically less than about 3 or 4 mole percent diethylene glycol content. In turn, these polyamide-compatible polyethylene terephthalate polymers facilitate the manufacture of polyamide-polyester bottles that, as compared to conventional polyamide-polyester bottles, possess reduced diethylene glycol content and superior clarity while maintaining excellent barrier properties.

Those having ordinary skill in the art will understand that the two-step ester exchange reaction between dimethyl terephthalate and excess ethylene glycol is less acidic than the direct esterification reaction between terephthalic acid and excess ethylene glycol. Even so, the sulfonated organic compound is introduced to the polyethylene terephthalate precursors after the initiation of the transesterification reaction to reduce the formation of unwanted byproducts, such as diethylene glycol. In this regard, the sulfonated organic compound can be introduced to the polyethylene terephthalate precursors after the completion of the transesterification reaction, such as just prior to the initiation of melt phase polycondensation.

Whether the polyethylene terephthalate precursors are formed via direct esterification or ester interchange, the reaction between the sulfonated organic compound and the polyethylene terephthalate precursors typically proceeds at less than about 270° C. (e.g., between about 255° C. and 265° C.).

With respect to continuous polyester processes, the sulfonated organic compound is typically introduced into polyethylene terephthalate precursors during esterification, though it can be introduced after esterification as well (e.g., just prior to the initiation of melt phase polycondensation).

With respect to batch or semi-continuous processes, the sulfonated organic compound is usually introduced into polyethylene terephthalate precursors after esterification or transesterification.

In a typical, exemplary process, the continuous feed enters a direct esterification vessel that is operated at a temperature of between about 240° C. and 290° C. and at a pressure of between about 5 and 85 psia (30−590 kPa) for between about one and five hours. The esterification reaction forms polyethylene terephthalate precursors having an average degree of polymerization of between about 4 and 6, as well as water. The water is removed as the reaction proceeds to drive favorable reaction equilibrium.

The polyethylene terephthalate precursors are then reacted with a sulfonated organic compound, typically a sulfonated isophthalate derivative such as dimethyl sulfoisophthalate sodium salt, at between about 255° C. and 265° C. to yield modified polyethylene terephthalate precursors. In keeping with the prior discussion, the introduction of the sulfonated organic compound is delayed until the carboxyl end group concentration of the esterification reaction is less than about 1000 microequivalents per gram (e.g., between about 400 and 800 microequivalents per gram).

Thereafter, the modified polyethylene terephthalate precursors are polymerized via melt phase polycondensation to form polyamide-compatible polyethylene terephthalate polymers. This polycondensation stage generally employs a series of two or more vessels and is operated at a temperature of between about 250° C. and 305° C. for between about one and four hours. The polycondensation reaction usually begins in a first vessel called the low polymerizer. The low polymerizer is operated at a pressure range of between about 0 and 70 torr (0−9.3 kPa).

In particular, the modified polyethylene terephthalate precursors polycondense to form polyamide-compatible polyethylene terephthalate polymers and ethylene glycol. The ethylene glycol is removed from the polymer melt using an applied vacuum to drive the reaction to completion. In this regard, the polymer melt is typically agitated to promote the escape of the ethylene glycol from the polymer melt and to assist the highly viscous polymer melt in moving through the polymerization vessel.

As the polymer melt is fed into successive vessels, the molecular weight and thus the intrinsic viscosity of the polymer melt increases. The temperature of each vessel is generally increased and the pressure decreased to allow greater polymerization in each successive vessel.

The final vessel, typically referred to as the “high polymerizer,” is operated at a pressure of between about 0 and 40 torr (0−5.3 kPa). Like the low polymerizer, each of the polymerization vessels is connected to a vacuum system having a condenser, and each is typically agitated to facilitate the removal of ethylene glycol. The residence time in the polymerization vessels and the feed rate of the ethylene glycol and terephthalic acid into the continuous process is determined, in part, based on the target molecular weight of the polyamide-compatible polyethylene terephthalate polymers. Because the molecular weight can be readily determined based on the intrinsic viscosity of the polymer melt, the intrinsic viscosity of the polymer melt is generally used to determine polymerization conditions, such as temperature, pressure, the feed rate of the reactants, and the residence time within the polymerization vessels. In this regard, the melt phase polymerization generally continues until the polyethylene terephthalate possesses an intrinsic viscosity of at least about 0.45 dL/g (e.g., between about 0.55 and 0.65 dL/g).

Note that in addition to the formation of polyamide-compatible polyethylene terephthalate polymers, side reactions occur that produce undesirable byproducts. For example, the esterification of ethylene glycol forms diethylene glycol, which is incorporated into the polymer chain. As is known to those of skill in the art, diethylene glycol lowers the softening point of the polymer. Moreover, cyclic oligomers (e.g., trimer and tetramers of terephthalic acid and ethylene glycol) may occur in minor amounts. The continued removal of ethylene glycol as it forms in the polycondensation reaction will generally reduce the formation of these byproducts.

After exiting the polycondensation stage, usually from the high polymerizer, the polymer melt is generally filtered and extruded. After extrusion, the polyamide-compatible polyethylene terephthalate polymers are quenched and solidified, typically by spraying with water. The solidified polyamide-compatible polyethylene terephthalate polymers are cut into chips or pellets for storage and handling purposes. The polyester pellets typically have an average mass of about 15-20 mg. As noted previously, the term “pellets” is used generally to refer to chips, pellets, and the like.

Usually, the pellets formed from the polyamide-compatible polyethylene terephthalate polymers can be subjected to crystallization. Thereafter, the polyamide-compatible polyethylene terephthalate polymers can be further polymerized in the solid state to increase molecular weight, typically to an intrinsic viscosity of at least about 0.6 dL/g (e.g., between about 0.65 and 0.85 dL/g). These subsequent steps, however, are constrained by the degree of polyester modification. As a practical matter, high levels of comonomer substitution preclude subsequent crystallization and solid state polymerization.

Those having ordinary skill in the art will appreciate, however, that during subsequent polymer processing operations (e.g., injection molding of preforms), polyethylene terephthalate copolyesters may lose intrinsic viscosity. The polyamide-compatible polyethylene terephthalate polymers of the present invention are no different in this regard. From chip to preform such intrinsic viscosity loss is typically between about 0.02 dL/g and 0.06 dL/g.

Although the prior exemplary discussion relates to a continuous production process, it will be understood that the invention is not so limited. The teachings disclosed herein with respect to the preparation of polyamide-compatible polyethylene terephthalate polymers may be applied to semi-continuous processes and even batch processes.

As discussed previously, the polyamide-compatible polyethylene terephthalate polymers typically include less than about 10 mole percent comonomer substitution, including less than about 2 mole percent sulfonated organic compound substitution. The polyamide-compatible polyethylene terephthalate polymers may be blended with up to 30 weight percent polyamide polymers to thereby form a polyamide-polyester barrier blend.

In accordance with the foregoing, exemplary polyester resin pellets that are suitable for compounding with polyamide polymers are mostly polyamide-compatible polyethylene terephthalate polymers. These polyamide-compatible polyethylene terephthalate polymers are composed of (i) a terephthalate moiety that includes at least about 95 mole percent terephthalic acid (or its dialkyl ester, dimethyl terephthalate) and between about 0.1 and 2.0 mole percent sulfonated organic compound and (ii) a diol moiety that includes ethylene glycol and less than about 6 mole percent diethylene glycol. In addition, when intended for packaging applications, such polyamide-compatible polyethylene terephthalate polymers further possess an intrinsic viscosity of at least about 0.80 dL/g and a b* color value of less than about 4 as classified by the CIE L*a*b* color space as measured on either amorphous pellets or crystalline pellets.

Likewise, exemplary polyamide-polyester polymer blends according to the present invention typically include at least about 70 weight percent polyamide-compatible polyethylene terephthalate polymers and less than about 30 weight percent polyamide polymers (e.g., between about 0.5 and 15 weight percent polyamide polymers). As noted, the polyamide-compatible polyethylene terephthalate polymers are typically composed of (i) a terephthalate moiety that includes at least about 95 mole percent terephthalic acid (or its dialkyl ester, dimethyl terephthalate) and between about 0.1 and 2.0 mole percent sulfonated organic compound and (ii) a diol moiety that includes ethylene glycol and less than about 6 mole percent diethylene glycol.

In one embodiment, the polyamide-polyester barrier blends are formed into preforms, which can thereafter be formed into polyester containers (e.g. beverage bottles).

In a first preferred embodiment, the container is a high-clarity, carbonated soft drink bottle. The carbonated soft drink bottle according to the present invention is capable of withstanding internal pressures of about 60 psig (400 kPa).

In a second preferred embodiment, the container is a high-clarity, hot-fill bottle. With respect to preforms that are used to make hot-fill bottles, heat-setting performance diminishes at higher intrinsic viscosity levels and mechanical properties (e.g., stress cracking, drop impact, and creep) decrease at lower intrinsic viscosity levels.

When used for preforms and bottles, the polyamide-compatible polyethylene terephthalate polymers can include additional comonomer substitution (i.e., modification in addition to the sulfonated organic compound modification). In this regard, isophthalic acid is an effective modifier (e.g., between about 1 and 4 mole percent isophthalic acid substitution).

Moreover, when used for polyamide-polyester preforms and bottles, the polyamide-compatible polyester resins may include a heat-up rate additive, which promotes the absorption of energy during preform reheating processes. See, e.g. commonly assigned U.S. patent application Ser. No. 10/850,918, for Slow-Crystallizing Polyester Resins, filed May 21, 2004, and Ser. No. 10/996,789, for Polyester Preforms Useful for Enhanced Heat-Set Bottles, filed Nov. 24, 2004.

Polyethylene terephthalate is typically converted into a container via a two-step process. First, an amorphous bottle preform (e.g., less than about 4 percent crystallinity) is produced by melting bottle resin in an extruder and injection molding the molten polyester into a preform. Such a preform usually has an outside surface area that is at least an order of magnitude smaller than the outside surface of the final container. The preform is reheated by passing the preforms through a reheat oven of a blow molding machine. The reheat oven may consist of a bank of quartz lamps (3,000 and 2,500 watt lamps) that emits radiation mostly in the infrared range.

The reheated preform is then placed into a bottle blow mold and, by stretching and inflating with high-pressure air, formed into a heated bottle. The blow mold is maintained at a temperature between about 115° C. and 200° C., usually between about 120° C. and 160° C.

Those having ordinary skill in the art will understand that the introduction of compressed air into the heated preform effects formation of the heated bottle. Thus, in one variation, the compressed air is turbulently released from the bottle by the balayage technique to facilitate cooling of the heated bottle.

Those of ordinary skill in the art will further understand that any defect in the preform is typically transferred to the bottle. Accordingly, the quality of the bottle resin used to form injection-molded preforms is critical to achieving commercially acceptable bottles. Aspects of injection-molding preforms and stretch-blow molding bottles are discussed in U.S. Pat. No. 6,309,718 for Large Polyester Containers and Methodfor Making the Same, which is hereby incorporated entirely herein by reference.

In polyethylene terephthalate bottle production, the ability of the preform to absorb radiation and convert it into heat is critical to efficient bottle production and optimum bottle performance (e.g., material distribution, orientation, and sidewall crystallinity).

Preform reheat temperature is important for optimal bottle performance. Though it varies depending on the application (e.g., hot-filled beverage bottle or carbonated soft drink bottles), reheat temperature is typically in the range of 30-50° C. above the glass transition temperature (T_{G}).

Furthermore, the rate at which a preform can be reheated to the orientation temperature is important for optimal bottle performance in high-speed, polyethylene terephthalate blow-molding machines, such as those manufactured by Sidel, Inc. (LeHavre, France). This is especially true for heat-set bottles that are intended for filling with hot liquids in excess of 185° F. (85° C.). In heat-set bottle production, the preform is reheated rapidly to as high a temperature as possible. This maximizes crystallization upon blow molding and avoids thermal crystallization in the preform. Those having ordinary skill in the art will appreciate that such thermal crystallization can cause unacceptable haze as a result of spherulitic crystallization.

In general, higher comonomer substitution disrupts crystallization, thereby improving clarity and impact resistance. Most modifiers, however, reduce glass transition temperature (T_{G}), and so heat-setting is enhanced at lower comonomer substitution (e.g., less than about 2 mole percent comonomer substitution).

In another embodiment, polyamide-polyester barrier blends are formed into unoriented films. In a related embodiment, the polyamide-polyester barrier blends are formed into either uniaxially oriented film or biaxially oriented film.

In yet another embodiment, polyamide-polyester barrier blends are formed into sheets (e.g. 1+ millimeter sheets), either unoriented or oriented. When modified with UV blockers, such sheets are especially durable despite prolonged exposure to sunlight.

In yet another embodiment, polyamide-polyester barrier blends are formed into articles, such as by injection molding. When intended for injection molding, polyamide-polyester barrier blends can be modified with fillers (e.g., glass or minerals) to provide an engineering resin. Alternatively, polyamide-polyester barrier blends are suitable for use as unfilled engineering resin.

In still other embodiments, polyamide-polyester barrier blends are formed into fibers. Such fibers may be further formed into textile materials and products, such as yarns and fabrics.

With respect to polyamide-polyester fiber embodiments, the polyamide-compatible polyester polymers are usually polymerized only in the melt phase (i.e., the resins usually do not undergo solid state polymerization). Moreover, when used for fibers, the polyamide-compatible polyester polymers do not require additional comonomer substitution.

Advantageously, the polyamide-compatible polyester polymers of the present invention may be directly compounded with polyamide polymers. Indeed, the present invention requires that the polyamide-polyester polymer blend be subjected to the melt phase just once to effect compounding and forming of an article (e.g., a preform, a container, a sheet, or a film). By facilitating blending and forming (e.g., injection molding, melt extrusion, or thermoforming operations) without multiple heat and cooling steps, the polyamide-polyester polymer blend does not acquire unfavorable heat histories, which cause polymer yellowing.

In accordance with the foregoing, initial blending of the polyamide-compatible polyethylene terephthalate polymers and the polyamide polymers usually includes melt blending, which is followed by forming operations while the polyamide-polyester polymer blend is already in the melt phase. Alternatively, the polyamide-compatible polyethylene terephthalate polymers and the polyamide polymers may be mixed as solids to form premixed polyamide-polyester polymer blends. These kinds of premixed polyamide-polyester polymer blends may be convenient for users that prefer to have polymer suppliers control the polyamide-polyester polymer formulations (i.e., QA/QC). Accordingly, both dry blending and melt blending of the polyamide-compatible polyethylene terephthalate polymers and the polyamide polymers are within the scope of the invention.

The following are non-limiting examples of the present invention.

### EXAMPLES

Polyamide-compatible polyethylene terephthalate polymers (“polymer”) were prepared using a slurry of terephthalic acid, isophthalic acid, ethylene glycol (to facilitate polymerization, a nominal 15 percent molar excess of ethylene glycol is used), antimony trioxide, and cobalt acetate. This is the batch charge (“BC”). The slurry was esterified for approximately two hours at 260° C. and a pressure of 40 psi (280 kPa). Under these conditions, the acids esterify to approximately 90 percent completion and diethylene glycol begins to form. Next, the pressure is reduced to atmospheric. At this point, DMSIP may be added as an ethylene glycol slurry.

Esterification is continued at atmospheric pressure (i.e., atmospheric esterification, or “AE”) for approximately one hour at 265° C., followed by the addition of a phosphoric acid/ethylene glycol solution as a stabilizer. The reaction temperature is increased to 285° to 290° C. and the pressure is gradually reduced to about 1 torr (0.1 kPa). During this time, polymer molecular weight and melt viscosity increase. When the polymer reaches a melt viscosity indicative of 18,000 to 20,000 g/mole the polymerization is terminated, the polymer discharged from the reactor, and formed into chips. Higher molecular weight polymers (e.g., intrinsic viscosity in excess of 0.70 dL/g) can then be produced via solid state polymerization in a vacuum or nitrogen environment for 10 to 12 hours at 210-220° C. Thereafter, the vacuum is let down (i.e., vacuum let down or “VLD”).

Table 1 shows the results of varying the timing of addition and the amount of sodium salt sulfoisophthalate derivatives into polyethylene terephthalate polymers prepared as described. The results are measured with respect to polymer quality and mole percent of diethylene glycol. In this experiment, DMSIP produced the most favorable results when added at a concentration of 0.5 percent during atmospheric esterification (“AE”). In this sample, the DMSIP dissolved completely into the polymer and the diethylene glycol level was 3.1 mole percent. Higher DMSIP levels added during atmospheric esterification yielded a slightly higher mole percentage of diethylene glycol. In contrast, DMSIP added during the batch charge yielded undesirably higher diethylene glycol levels (i.e., 8.0 mole percent). Furthermore, 2.0 percent DMSIP added during the batch charge resulted in small precipitates in the polymer.

TABLE 1

| | sulfoisophthalate | | | |
|---|---|---|---|---|
| | level | addition | polymer | DEG level |
| sulfoisophthalate | (mole %) | point | quality | (mole %) |
| DMSIP-Na | 2.0 | BC | small | 8.0 |
| | | | precipitates | |
| DMSIP-Na | 0.1 | BC | clear | 6.5 |
| DMSIP-Na | 0.5 | AE | clear | 3.1 |
| DMSIP-Na | 2.0 | AE | clear | 3.7 |
| DMSIP-Na | 0.5 | VLD | undissolved | 5.1 |

In the next experiment, polyethylene terephthalate bottles made from the above process were evaluated for sidewall haze and carbon dioxide (CO₂) barrier property. Polymers lacking or containing from 0.2, 0.50, or 1.0 mole percent DMSIP were produced as described above, with DMSIP added during atmospheric esterification. The polymers were then dry blended with 2 weight percent of the nylon-MXD6 polyamide. The control polymer lacked nylon-MXD6 and DMSIP. Thereafter, bottles were formed and evaluated. Table 2 shows a more than two week increase in shelf life between the control bottle compared with the same bottle blended with 2 weight percent nylon-MXD6. For the purpose of this experiment, shelf life is defined by a 17.5 percent loss in product carbonation (i.e., CO₂ loss). The bottle sidewall haze, however, is much greater. DMSIP-containing polyester bottles reduced the sidewall haze (as compared with the blended, non-DMSIP-containing bottle) at all levels tested. Furthermore, there is no decrease in shelf life with the DMSIP-containing polyester bottles.

TABLE 2

| | | CO₂ shelf life |
|---|---|---|
| polymer | bottle haze (%) | (weeks) |
| control polyester (PET) | 1.5 | 9.6 |
| (2.8 mol % IPA; 3.0 mol % DEG) | | |
| control + 2 wt % nylon-MXD6 | 4.8 | 11.8 |
| control + 0.2 mol % DMSIP + 2 wt | 3.4 | 11.6 |
| % nylon-MXD6 | | |
| control + 0.5 mol % DMSIP + 2 wt | 2.5 | 12.1 |
| % nylon-MXD6 | | |

In yet another experiment, the effect of 0.5 percent DMSIP on polyethylene terephthalate bottle sidewall haze was measured using 16-ounce (˜500-milliliter) carbonated soft drink bottles. The bottles were made according to the above general procedure. 0.5 mole percent DMSIP was either omitted or added to polyethylene terephthalate resin during atmospheric esterification. Thereafter, the resin was blended with 0, 2, or 4 weight percent nylon-MXD6. FIG. 5 depicts the reduction in sidewall haze in 0.5 mole percent DMSIP-containing bottles compared with DMSIP-lacking bottles at the indicated percentages of polyamide blend. At 2 weight percent nylon-MXD6, the sidewall haze reduction is greater than two-fold. At 4 weight percent nylon-MXD6, the reduction in sidewall haze is nearly three-fold.

In yet another experiment, DMSIP-modified copolyesters were analyzed for unreacted (i.e., residual) DMSIP. The analysis involved two steps. The first step is separating the low molecular weight species (oligomers) from the polymer by gel permeation chromatography (GPC). The second step is analyzing the oligomers isolated by GPC for unreacted DMSIP using high pressure liquid chromatography (HPLC). This method will resolve (but not specifically identify) oligomers up to hexamers. Given a nominal polyethylene terephthalate molecular weight of 192, this HPLC analysis covers oligomers up to roughly 1000 molecular weight. HPLC will quantify terephthalic acid (TA), 2-hydroxyethylterephthalate (MHET), bis-(2-hydroxyethyl)-terephthalate (BHET), and cyclic trimer. The concentrations of other oligomers can be closely approximated based on the HPLC response factor for cyclic trimer.

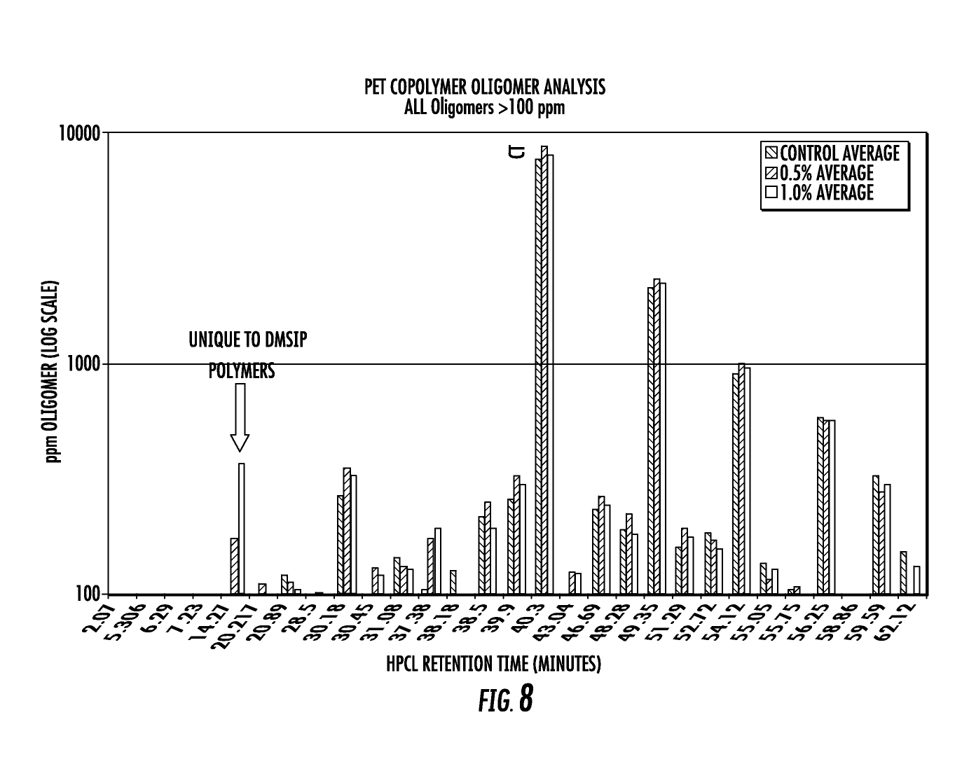

Table 3 details the polymer formulations for this experiment, including mole percentages of 0.0, 0.5, and 1.0 mole percent for DMSIP. Table 4 shows the unreacted DMSIP, measured by HPLC in parts per million (ppm) for polymer containing 0.0, 0.5, or 1.0 mole percent DMSIP. Each sample was performed in duplicate. Table 5 shows the tabulated data for oligomers present at concentrations over 100 ppm. Table 5 further shows unreacted terephthalic acid (TA), unreacted 2-hydroxyethylterephthalate (MHET), unreacted bis-(2-hydroxyethyl)-terephthalate (BHET), and unreacted DMSIP, measured in ppm. In the data shown in Table 5, one oligomer was found unique to DMSIP polymers. This oligomer possesses a HPLC retention time of approximately 14.27 minutes. FIG. 8 depicts Table 5, with HPLC retention time shown on the x-axis and ppm shown on a logarithmic y-axis.

Table 6 shows the comparison, by percentage, of oligomers present at greater than 100 ppm compared with the total ppm of oligomers for polymer lacking or containing 0.5 or 1.0 mole percent DMSIP. In summary, the data show that the presence of DMSIP does not contribute to the percentage of oligomers present in an amount greater than 100 ppm.

TABLE 3

| | standard | | 0.5-percent | | 1.0-percent | |
|---|---|---|---|---|---|---|
| | copolyester | | DMSIP copolyester | | DMSIP copolyester | |
| | weight % | mole % | weight % | mole % | weight % | mole % |
| MONOMERS | | | | | | |
| terephthalic acid | 70.5 | 97.2 | 69.8 | 97.2 | 69.6 | 97.2 |
| isophthalic acid | 2.0 | 2.8 | 2.0 | 2.8 | 1.7 | 2.3 |
| DMSIP | 0 | 0 | 0.6 | 0.5 | 1.3 | 1.0 |
| ethylene glycol | 26.4 | 97.6 | 26.1 | 96.6 | 26.0 | 96.6 |
| diethylene glycol | 1.1 | 2.4 | 1.6 | 3.4 | 1.6 | 3.4 |

| | | | |
|---|---|---|---|
| POLYMER ADDITIVES | parts per million | parts per million | parts per million |
| antimony trioxide | 300 | 300 | 300 |
| cobalt acetate | 100 | 100 | 100 |
| tetrahydrate | | | |
| phosphoric acid | 95 | 95 | 95 |
| sodium acetate | 0 | 212 | 415 |
| POLYMER PROPERTIES | | | |
| intrinsic viscosity (dL/g) | 0.80 | 0.60 | 0.55 |
| molecular weight (g/mol) | 26,600 | 18,800 | 16,900 |
| (from IV) | | | |

TABLE 4

| | | | 0.5 mole | | 1.0 mole | |
|---|---|---|---|---|---|---|
| | control | | % DMSIP | | % DMSIP | |
| | 001 | 001A | 002 | 002A | 003 | 003A |
| DMSIP | (ppm) | (ppm) | (ppm) | (ppm) | (ppm) | (ppm) |
| individual | 0.0 | 0.0 | 12.1 | 7.5 | 16.5 | 0.0 |
| analysis | | | | | | |

| | | | |
|---|---|---|---|
| average ppm | 0.0 | 9.8 | 8.3 |

TABLE 5

| | HPLC | | | 0.5 mole | | 1.0 mole | |
|---|---|---|---|---|---|---|---|
| | retention | Control | | % DMSIP | | % DMSIP | |
| | time | 001 | 001A | 002 | 002A | 003 | 003A |
| oligomer | (minutes) | (ppm) | (ppm) | (ppm) | (ppm) | (ppm) | (ppm) |
| DMSIP | 2.07 | 0.0 | 0.0 | 12.1 | 7.5 | 16.5 | 0.0 |
| TA | 5.31 | 7.3 | 6.4 | 5.8 | 8.6 | 4.7 | 6.1 |
| MHET | 6.29 | 51.0 | 47.6 | 57.7 | 58.8 | 64.1 | 69.0 |
| BHET | 7.23 | 75.1 | 74.6 | 54.6 | 54.7 | 50.5 | 47.7 |
| * | 14.27 | 0.0 | 0.0 | 172.3 | 173.9 | 358.0 | 372.0 |
| | 20.22 | 65.0 | 62.5 | 106.2 | 109.9 | 43.0 | 121.4 |
| | 20.89 | 120.6 | 120.3 | 111.6 | 108.8 | 102.4 | 102.8 |
| | 28.50 | 90.0 | 88.6 | 95.3 | 105.9 | 94.1 | 96.7 |
| | 30.18 | 269.2 | 265.4 | 350.3 | 345.0 | 324.0 | 320.2 |
| | 30.45 | 94.8 | 90.4 | 129.8 | 128.7 | 119.3 | 120.1 |
| | 31.08 | 142.0 | 143.7 | 134.2 | 129.9 | 148.9 | 107.1 |
| | 37.38 | 104.7 | 100.5 | 174.2 | 172.3 | 193.7 | 190.1 |
| | 38.18 | 126.0 | 124.5 | 87.1 | 75.3 | 80.3 | 96.5 |
| | 38.50 | 215.8 | 211.5 | 250.5 | 243.4 | 195.0 | 186.4 |
| | 39.90 | 257.9 | 253.0 | 325.2 | 320.1 | 303.8 | 288.0 |
| cyclic trimer | 40.30 | 7741.0 | 7576.0 | 8781.0 | 8657.0 | 8277.0 | 7927.0 |
| | 43.04 | 94.2 | 92.3 | 131.1 | 115.4 | 112.8 | 131.6 |
| | 46.69 | 233.9 | 227.0 | 271.6 | 260.0 | 240.1 | 240.4 |
| | 48.28 | 189.7 | 184.0 | 225.4 | 214.0 | 179.3 | 181.2 |
| | 49.35 | 2210.0 | 2097.0 | 2387.0 | 2222.0 | 2194.0 | 2250.0 |
| | 51.29 | 161.8 | 158.0 | 193.6 | 186.2 | 164.8 | 185.0 |
| | 52.72 | 189.2 | 178.5 | 171.7 | 164.7 | 141.3 | 171.5 |
| | 54.12 | 925.4 | 898.4 | 1015.0 | 968.0 | 901.8 | 992.0 |
| | 55.05 | 139.1 | 130.7 | 121.7 | 107.0 | 110.0 | 145.8 |
| | 55.75 | 104.2 | 101.6 | 105.7 | 104.7 | 75.3 | 91.2 |
| | 56.25 | 579.6 | 567.9 | 588.3 | 551.0 | 504.0 | 631.0 |
| | 58.86 | 89.0 | 105.2 | 72.0 | 59.2 | 52.8 | 82.9 |
| | 59.59 | 314.8 | 323.0 | 295.1 | 250.1 | 252.0 | 341.0 |
| | 62.12 | 157.2 | 145.1 | 101.1 | 87.0 | 110.7 | 150.0 |

| | | | | | | |
|---|---|---|---|---|---|---|
| total oligomers | 14615.1 | 14245.1 | 16397 | 15859.5 | 15278.4 | 15521.9 |
| (>100 ppm) | | | | | | |

*oligomer species unique to DMSIP polymers

TABLE 6

| | | | 0.5 mole | | 1.0 mole | |
|---|---|---|---|---|---|---|
| | Control | | % DMSIP | | % DMSIP | |
| | 001 | 001A | 002 | 002A | 003 | 003A |
| Oligomers | (ppm) | (ppm) | (ppm) | (ppm) | (ppm) | (ppm) |
| oligomers | 14748.5 | 14373.7 | 16527.2 | 15989.1 | 15414.2 | 15644.7 |
| (>100 ppm) | | | | | | |
| total | 15999 | 15737 | 17365 | 18017 | 17121 | 17556 |
| oligomers by | | | | | | |
| HPLC | | | | | | |
| oligomer | 92.2% | 91.3% | 95.2% | 88.7% | 90.0% | 89.1% |
| fraction | | | | | | |
| (>100 ppm) | | | | | | |

As discussed previously, to enhance gas barrier properties, polyamides (i.e., nylons) can be blended with various polyesters to improve shelf life of polyester packages, such as carbonated soft drink (CSD) bottles.

Surprisingly, it has been discovered that polyester containers formed from the polyamide-polyester barrier blends according to the present invention—and even polyester containers formed from conventional polyamide-polyester polymer blends—can be more cost-effectively recycled within the polyethylene terephthalate recycling steam if the polyester polymers, the polyamide polymers, or both, are enhanced with antioxidants.

Spent polyamide-containing polyester containers—especially monolayer bottles—pose a problem for bottle recyclers. When such containers become mixed with containers formed entirely of polyethylene terephthalate, the residual polyamide-polymers may degrade the recovered polyester.

In particular, the downstream processing of polyamide-containing polyester containers—like the processing of polyester containers in general—typically requires drying, extrusion, and solid stating steps. These heated unit operations tend to cause yellowing of the polyamide polymer component of the polyamide-polyester polymer blend. If polyamide-containing polyester containers go undetected by conventional recycling sorting methods and thereby enter the polyethylene terephthalate recycle stream, the subsequent yellowing of the polyamide polymers during recycling unit operations can reduce the usefulness of the recovered polyethylene terephthalate polymer.

The presence of antioxidants has been found to reduce unwanted yellowing of the recovered polyamide-polyester polymer blend. For example, antioxidants can be added to the recycle stream during extrusion of the recovered polyamide-polyester polymer blend.

More cost effective, however, is to form polyamide-containing polyester containers using polyamide-polyester polymer barrier blends that are enhanced with sufficient quantities of antioxidants to facilitate subsequent recycling. For example, antioxidants can be added to either polyethylene terephthalate polymers or polyamide polymers before forming the polyamide-polyester polymer barrier blends. It is these blends that, in turn, can be used to form polyamide-containing polyester containers-containers that will either be disposed of or recycled after use.

To achieve favorable recycling of the polyamide-polyester polymer blends within the polyethylene terephthalate recycling stream, antioxidants should be present in the polymer blend in sufficient quantities to reduce yellowing of the polyamide polymers during subsequent recycling unit operations. For example, phenolic antioxidants that are present in the polyamide-polyester polymer blends in amounts between about 500 and 5,000 ppm effectively reduce yellowing of the polyamide polymers. Typically, phenolic antioxidants are present in the polyamide-polyester polymer blends in amounts between about 1,000 and 3,000 (e.g. between about 1,500 and 2,500 ppm or more). (As noted, to achieve these exemplary concentrations, phenolic antioxidants may be added to the polyethylene terephthalate polymers, to the polyamide polymers, or to blends of polyamide and polyester polymers.)

Antioxidants that are added to either polyethylene terephthalate polymers or polyamide polymers before blending do not adversely affect these polymers during subsequent forming operations (e.g. injection molding of preforms and stretch-blow molding of bottles). Indeed, polyamide-containing polyester preforms and bottles that are formed from antioxidant-enhanced polyamide-polyester polymer blends are virtually indistinguishable from other polyamide-containing polyester preforms and bottles. It is during recycling (e.g., extrusion and SSP) that the efficacy of the antioxidants becomes most significant. This is so, in fact, irrespective of whether or not the polyamide-polyester polymer blends are compatibilized according to the other aspects of the present invention.

By way of example, (i) monolayer CSD bottles formed from a blend of about four (4) weight percent nylon-MXD6 and antioxidant-free, DMSIP-modified polyethylene terephthalate resin and (ii) monolayer CSD bottles formed from a blend of about four (4) weight percent nylon-MXD6 and antioxidant-enhanced, DMSIP-modified polyethylene terephthalate resin were recycled. In particular, the antioxidant-enhanced, DMSIP-modified polyethylene terephthalate resin included about 1,300 ppm of a phenolic antioxidant (i.e., the blend thus included about 1,250 ppm of the phenolic antioxidant). As measured upon three-millimeter, non-crystalline polyamide-polyester test plaques, the polyamide-polyester polymer blends recovered from the “antioxidant-enhanced” CSD bottles possessed significantly less yellowness (e.g., a b* color value of less than about 6.6) as compared with the polyamide-polyester polymer blends recovered from the “antioxidant-free” CSD bottles (e.g., a b* color value of 23.0).

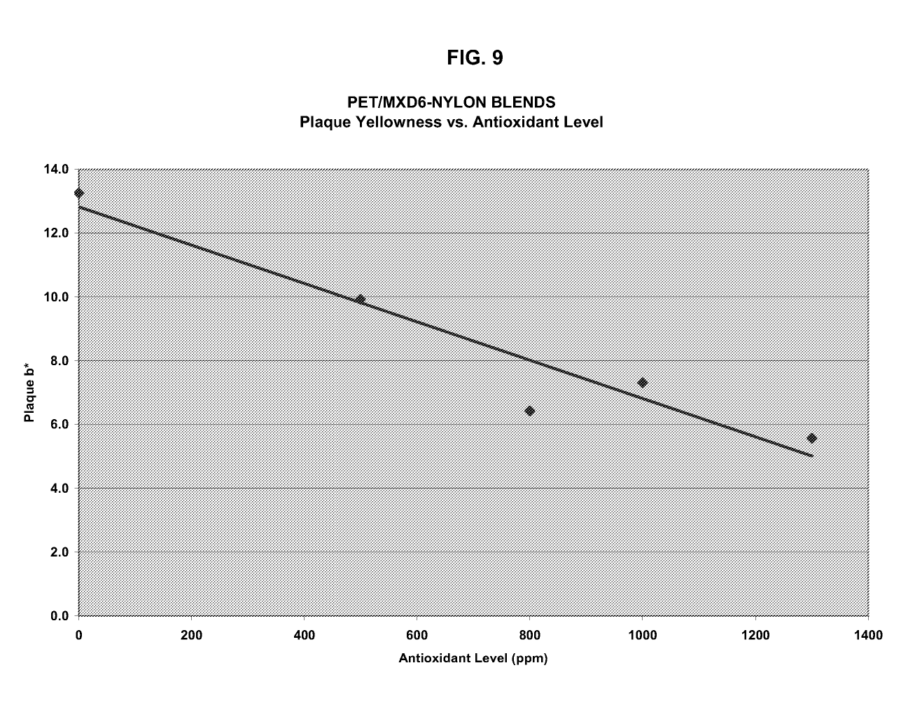

In addition, experiments have been performed to simulate the effects that heated recycling unit operations (i.e., a heat history) can have on a polyester recycling stream contaminated with about ten (10) percent polyamide-polyester polymer blends (i.e., 1/8). These experiments illustrate the adverse effects that polyamide contamination can cause to a polyester recycle stream. The color (i.e., b* and L*) and haze data of the “recovered” polyester is reported in FIGS. 9-11.

Nylon-MXD6 was compounded at five (5) weight percent with polyethylene terephthalate resins modified with 0.5 mole percent DMSIP and various concentrations of phenolic antioxidant (i.e., between 0 and about 1,300 ppm). The resultant polyamide-polyester polymer blends were crystallized at about 130-140° C., then further compounded (and pelletized) in an extruder at about 250-260° C. with a conventional antimony-catalyzed polyethylene terephthalate resin at a 1:3 weight ratio (i.e., the resultant secondary blends included about 1.25 weight percent nylon-MXD6).

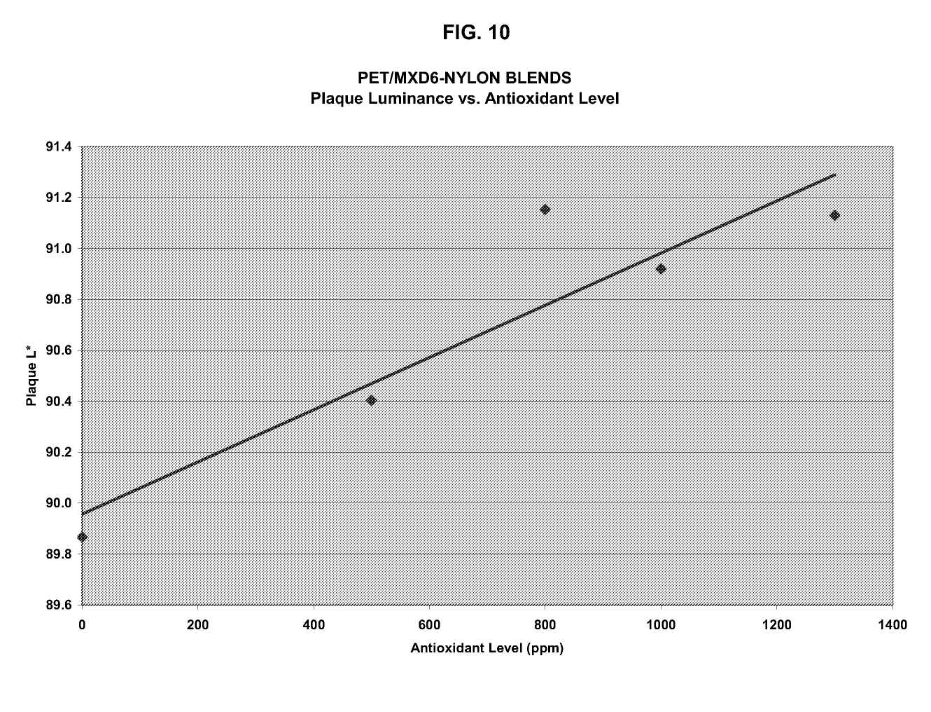

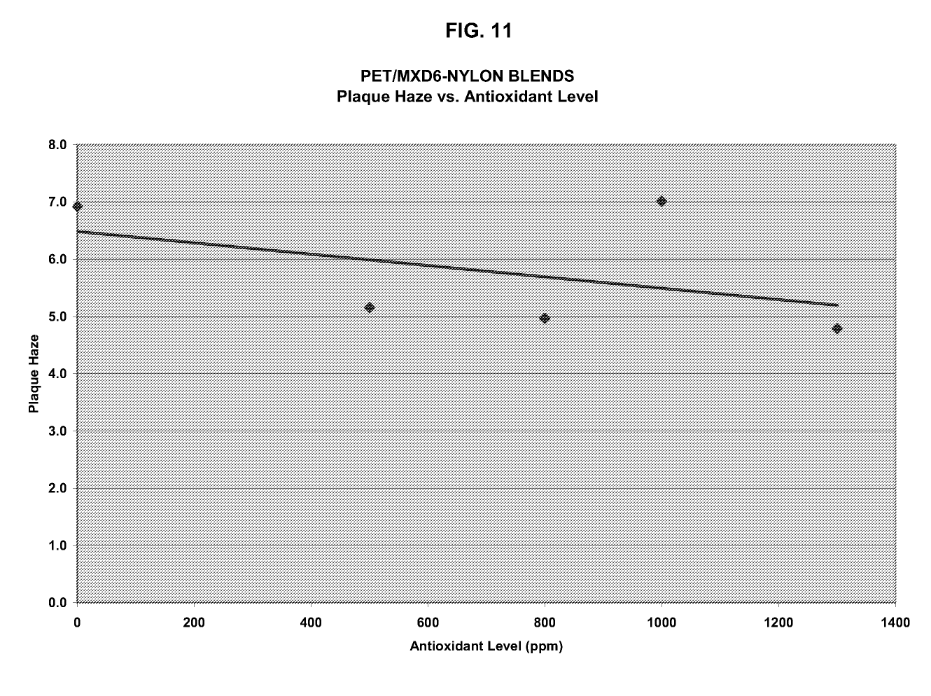

These secondary polyamide-polyester polymer blends were crystallized as pellets at about 130-140° C., then polymerized in the solid phase at a temperature of about 200-210° C. to achieve a target intrinsic viscosity of about 0.80 dL/g. The solid-stated polyamide-polyester polymer pellets were further compounded (and pelletized) in an extruder at about 250-260° C. with a conventional antimony-catalyzed polyethylene terephthalate resin at a 1:1 weight ratio (i.e., the resultant tertiary blends included about 0.625 weight percent nylon-MXD6). These tertiary polyamide-polyester polymer blends were injection molded to form three-millimeter, non-crystalline polyamide-polyester test plaques. These test plaques were measured for yellowness (FIG. 9), luminosity (FIG. 10), and plaque haze (FIG. 11) in accordance with the procedures discussed previously.

FIGS. 9-11 show that the inclusion of higher antioxidant concentrations (i.e., less than one weight percent nylon-MXD6) in the tertiary polyamide-polyester polymer blend significantly improved yellowness (i.e., b*) and somewhat improved luminosity (i.e., L*) and haze. Those having ordinary skill in the art will understand that reducing the adverse color effects that polyamide contamination can cause to a polyester recycle stream lessens the risk of polyamide contamination, in turn making the recycling of polyamide-containing polyester containers more cost effective.

As noted, polyamide-polyester recycling problems are particularly acute for monolayer bottles, but exist for multilayer containers, too, albeit to a lesser degree. For instance, during recycling of a multilayer container the polyamide layer is mostly removed from the recycle stream before extrusion. Nonetheless, the remaining polyester invariably includes some nylon contamination (i.e., there is imperfect separation of the respective layers). The subsequent heated extrusion and solid state polymerization operations can cause yellowing of the residual polyamide and thus the recovered polyamide-polyester polymer blend as well.

In the specification and figures, typical embodiments of the invention have been disclosed. Specific terms have been used only in a generic and descriptive sense and not for purposes of limitation.

1. A method for making an improved polyamide-polyester polymer blend, comprising:
reacting a terephthalate component and a diol component to form polyethylene terephthalate precursors;
thereafter reacting sulfonated organic compound with the polyethylene terephthalate precursors to yield modified polyethylene terephthalate precursors;
polymerizing the modified polyethylene terephthalate precursors to form polyamide-compatible polyethylene terephthalate polymers; and
blending polyamide polymers with the polyamide-compatible polyethylene terephthalate polymers to form a polyamide-polyester polymer blend.

2. A method according to claim 1, wherein each step, until the blending of the polyamide polymers with the polyamide-compatible polyethylene terephthalate polymers, is performed as a continuous process.

3. A method according to claim 1, wherein the step of reacting a terephthalate component and a diol component comprises reacting in an esterification reaction (i) a diacid component comprising terephthalic acid and (ii) a diol component comprising ethylene glycol.

4. A method according to claim 3, wherein the step of reacting a terephthalate component and a diol component comprises reacting a diacid component and a diol component in the presence of a buffer in an amount sufficient to control the acidity of the sulfonated organic compound and thereby reduce diethylene glycol formation during the esterification reaction.

5. A method according to claim 3, wherein the sulfonated organic compound is introduced to the polyethylene terephthalate precursors during the esterification reaction.

6. A method according to claim 3, wherein the sulfonated organic compound is introduced to the polyethylene terephthalate precursors after the completion of the esterification reaction.

7. A method according to claim 3, wherein the step of reacting sulfonated organic compound with the polyethylene terephthalate precursors comprises initiating a reaction between the sulfonated organic compound and the polyethylene terephthalate precursors when the polyethylene terephthalate precursors have a carboxyl end group concentration of between about 300 and 900 microequivalents per gram.

8. A method according to claim 1, wherein the step of reacting sulfonated organic compound with the polyethylene terephthalate precursors comprises initiating a reaction between the sulfonated organic compound and the polyethylene terephthalate precursors when the polyethylene terephthalate precursors have a carboxyl end group concentration of less than about 1000 microequivalents per gram.

9. A method according to claim 1, wherein the step of reacting sulfonated organic compound with the polyethylene terephthalate precursors comprises initiating a reaction between the sulfonated organic compound and the polyethylene terephthalate precursors when the polyethylene terephthalate precursors have a carboxyl end group concentration of between about 400 and 800 microequivalents per gram.

10. A method according to claim 1, wherein the step of reacting sulfonated organic compound with the polyethylene terephthalate precursors comprises introducing the sulfonated organic compound into polyethylene terephthalate precursors having an average degree of polymerization between about 2 and 10.

11. A method according to claim 1, wherein the step of reacting sulfonated organic compound with the polyethylene terephthalate precursors comprises introducing the sulfonated organic compound into polyethylene terephthalate precursors having an average degree of polymerization between about 3 and 6.

12. A method according to claim 1, wherein the sulfonated organic compound comprises mostly ionomeric sulfonated isophthalate derivatives.

13. A method according to claim 1, wherein the sulfonated organic compound comprises dimethyl sulfoisophthalate (DMSIP).

14. A method according to claim 1, wherein the step of polymerizing the modified polyethylene terephthalate precursors comprises polymerizing the modified polyethylene terephthalate precursors to form polyamide-compatible polyethylene terephthalate polymers comprising sulfonated organic compound substitution in an amount between about 0.1 and 2.0 mole percent.

15. A method according to claim 1, wherein the step of polymerizing the modified polyethylene terephthalate precursors comprises polymerizing the modified polyethylene terephthalate precursors to yield polyamide-compatible polyethylene terephthalate polymers that include less than about 6 mole percent diethylene glycol.

16. A method according to claim 1, wherein the step of polymerizing the modified polyethylene terephthalate precursors comprises polymerizing the modified polyethylene terephthalate precursors to yield polyamide-compatible polyethylene terephthalate polymers that include less than about 4 mole percent diethylene glycol.

17. A method according to claim 1, wherein the step of blending polyamide polymers with the polyamide-compatible polyethylene terephthalate polymers comprises blending less than about 30 weight percent polyamide polymers with at least about 70 weight percent polyamide-compatible polyethylene terephthalate polymers.

18. A method according to claim 17, wherein the step of blending polyamide polymers with the polyamide-compatible polyethylene terephthalate polymers comprises blending at least about 15 weight percent polyamide polymers with polyamide-compatible polyethylene terephthalate polymers to thereby form the polyamide-polyester polymer blend.

19. A method according to claim 1, wherein the step of blending polyamide polymers with the polyamide-compatible polyethylene terephthalate polymers comprises blending more than 10 weight percent polyamide polymers with polyamide-compatible polyethylene terephthalate polymers to thereby form the polyamide-polyester polymer blend.

20. A method according to claim 1, wherein the polyamide-compatible polyethylene terephthalate polymers include an antioxidant in an amount sufficient to reduce yellowing of the polyamide polymers during subsequent heating.

21. A method according to claim 1, wherein the polyamide polymers include an antioxidant in an amount sufficient to reduce yellowing during subsequent heating.

22. A method according to claim 1, wherein the step of blending polyamide polymers with the polyamide-compatible polyethylene terephthalate polymers comprises blending polyamide polymers, the polyamide-compatible polyethylene terephthalate polymers, and an antioxidant, the antioxidant being introduced in an amount sufficient to reduce yellowing of the polyamide polymers during subsequent heating.

23. A method according to claim 1, further comprising forming the polyamide-polyester polymer blend into an article.

24. A polyamide-polyester polymer blend having improved color, clarity, and barrier properties, comprising:
at least about 70 weight percent polyamide-compatible polyethylene terephthalate polymers composed of a terephthalate moiety and a diol moiety, wherein the terephthalate moiety comprises at least about 95 mole percent terephthalic acid or its dialkyl ester and between about 0.1 and 2.0 mole percent sulfonated organic compound, and wherein the diol moiety comprises ethylene glycol and less than about 6 mole percent diethylene glycol; and
between about 0.5 and 30 weight percent polyamide polymers.

25. A polyamide-polyester polymer blend according to claim 24, comprising at least 10 weight percent and less than 20 weight percent polyamide polymers.

26. A polyamide-polyester polymer blend according to claim 24, comprising at least about 15 weight percent polyamide polymers.

27. A polyamide-polyester polymer blend according to claim 24, wherein the sulfonated organic compound comprises mostly ionomeric sulfonated isophthalate derivatives.

28. A polyamide-polyester polymer blend according to claim 24, wherein the diol moiety comprises less than about 4 mole percent diethylene glycol.

29. A polyamide-polyester polymer blend according to claim 24, comprising:
at least about 95 weight percent polyamide-compatible polyethylene terephthalate polymers, wherein the terephthalate moiety comprises between about 0.2 and 1.0 mole percent of mostly ionomeric sulfonated isophthalate derivatives; and
between about 2 and 4 weight percent polyamide polymers, wherein the polyamide polymers comprise mostly nylon-MXD6 polyamide polymers.

30. A polyamide-polyester polymer blend according to claim 24, further comprising an antioxidant in an amount sufficient to reduce yellowing of the polyamide polymers during heated unit operations.

31. A polyamide-polyester polymer blend according to claim 24, further comprising a phenolic antioxidant that is present in the polymer blend in an amount between about 500 and 5,000 ppm.

32. A polyamide-polyester polymer blend according to claim 24, further comprising a phenolic antioxidant that is present in the polymer blend in an amount between about 1,000 and 3,000 ppm.

33. A polyamide-polyester polymer blend according to claim 24, further comprising a phenolic antioxidant that is present in the polymer blend in an amount greater than about 1,500 ppm.

34. A polyamide-polyester polymer container having excellent color, clarity, and barrier properties, comprising:
at least about 85 weight percent polyamide-compatible polyethylene terephthalate polymers composed of a terephthalate moiety and a diol moiety, wherein the terephthalate moiety comprises at least about 95 mole percent terephthalic acid or its dialkyl ester and between about 0.1 and 2.0 mole percent sulfonated organic compound, and wherein the diol moiety comprises ethylene glycol and less than about 6 mole percent diethylene glycol;
between about 0.5 and 15 weight percent polyamide polymers; and
an antioxidant in an amount sufficient to reduce yellowing of the polyamide polymers during heated recycling of the polyamide-polyester polymer container.

35. A polyamide-polyester polymer container according to claim 34, comprising:
at least about 95 weight percent polyamide-compatible polyethylene terephthalate polymers, wherein the terephthalate moiety comprises between about 0.2 and 1.5 mole percent of ionomeric sulfonated isophthalate derivatives; and
between about 1 and 5 weight percent polyamide polymers, wherein the polyamide polymers comprise nylon-MXD6 polyamide polymers.

36. A polyamide-polyester polymer container according to claim 34, wherein the polyamide-polyester polymer container possesses a b* color value of less than about 4 as measured on its sidewall.

37. A polyamide-polyester polymer container according to claim 34, wherein the polyamide-polyester polymer container possesses an L* value of more than about 90 and a b* color value of less than about 2 as measured on its sidewall.

38. A polyamide-polyester polymer container according to claim 34, wherein, wherein the diol moiety comprises less than about 4 mole percent diethylene glycol.

39. A polyamide-polyester polymer container according to claim 34, wherein the antioxidant comprises a phenolic antioxidant that is present in the polyamide-polyester polymer container in an amount greater than about 500 ppm.

40. A polyamide-polyester polymer container according to claim 34, wherein the antioxidant comprises a phenolic antioxidant that is present in the polyamide-polyester polymer container in an amount between about 1,000 and 3,000 ppm.
